(19) United States
(12) Patent Application Publication
(10) Pub. No.: US 2019/0001710 A1
(43) Pub. Date: Jan. 3, 2019

(54) INKJET RECORDING METHOD AND INKJET RECORDING APPARATUS

(71) Applicant: CANON KABUSHIKI KAISHA, Tokyo (JP)

(72) Inventors: Ryosuke Hirokawa, Kawasaki-shi (JP); Minoru Nozawa, Yokohama-shi (JP); Toshimori Miyakoshi, Yokohama-shi (JP)

(21) Appl. No.: 16/015,734

(22) Filed: Jun. 22, 2018

(30) Foreign Application Priority Data
Jun. 29, 2017 (JP) 2017-127483

(51) Int. Cl. B41J 11/00; B41J 2/165

(52) U.S. Cl. CPC B41J 11/0015; B41J 2/165

(57) ABSTRACT

An inkjet recording method includes a step of applying a reaction liquid onto an ejection receiving medium, a step of applying an ink onto the ejection receiving medium to form an ink image, a step of causing a first porous body to contact with the ink image to remove a liquid component contained therein, a first collecting step of absorbing the liquid component in the first porous body by means of a second porous body and a second collecting step of sucking and collecting the liquid component in the second porous body. The pore diameter of the second porous body is controlled in the first collecting step and in the second collecting step.

### BACKGROUND OF THE INVENTION

### Field of the Invention

The present invention relates to an inkjet recording method and also to an inkjet recording apparatus.

### Description of the Related Art

With inkjet recording systems, images are formed by directly or indirectly applying liquid compositions (inks) that contain coloring materials onto recording mediums such as sheets of paper. When forming images with inkjet recording systems, the phenomenon of curling and that of cockling can arise as recording mediums excessively absorb the liquid component in inks. For this reason, techniques of drying recording mediums by means of warm currents of air, infrared rays or the like and those of forming images on transfer bodies and, after drying the liquid component contained in the ink images on the transfer bodies, transferring the ink images onto recording mediums such as sheets of paper have been devised.

Additionally, as means of removing the liquid component contained in the ink images formed on transfer bodies, a technique of removing the liquid component by causing a porous body in the form of a roller to contact the ink image to absorb the liquid component from the ink image without using thermal energy at all has been proposed (Japanese Patent Application Laid-Open No. 2009-45851).

On the other hand, Japanese Patent Application Laid-Open No. H06-47911 discloses a technique as described below. A printing medium, to which magnetic fluid (liquid) is attached, is brought in and caused to contact a liquid absorbing roller to make the superabsorbent resin that is laminated onto the periphery of the liquid absorbing roller absorb the undried liquid and confine it in the inside thereof. When no recording operation is being conducted and hence the superabsorbent resin is at rest, the superabsorbent resin is dried by heating and caused to discharge the liquid confined in the inside thereof. The discharged liquid will then be collected.

On the other hand, Japanese Patent Application Laid-Open No. 2001-179959 discloses a liquid solvent absorber that absorbs the liquid solvent of ink. The absorber is provided in the inside hereof with a ventilation device and hence the liquid solvent absorbed by the absorber can be released from the inside of the absorber.

### SUMMARY OF THE INVENTION

The present invention is made to provide an inkjet recording method and an inkjet recording apparatus that can satisfactorily remove and collect the liquid component contained in ink images and can reduce the energy load of the liquid sucking device to be used for collecting the liquid component.

In an aspect of the present invention, there is provided an inkjet recording method including: a step of applying a reaction liquid onto an ejection receiving medium, the reaction liquid increasing viscosity of an ink after contacting with the ink; a step of applying the ink so as to make the applied ink overlap at least part of a region having the reaction liquid applied thereto, thereby forming an ink image on the ejection receiving medium; a step of bringing a first porous body into contact with the ink image, thereby removing at least part of a liquid component contained in the ink image; a first collecting step of absorbing the liquid component contained in the first porous body by means of a second porous body; and a second collecting step of sucking and collecting the liquid component contained in the second porous body, wherein the pore diameter of the second porous body is so controlled in the first collecting step as to be firstly made smaller by means of pressure application to the second porous body than the pore diameter of the second porous body prior to the pressure application and subsequently made larger by lowering or releasing the applied pressure than the pore diameter of the second porous body during the pressure application in a state that the second porous body is held in contact with the first porous body, and wherein the liquid component is collected in the second collecting step in a state that the pore diameter of the second porous body is made larger than the pore diameter of the second porous body during the pressure application in the first collecting step.

In another aspect of the present invention, there is provided an inkjet recording apparatus including: an ejection receiving medium; a reaction liquid applying unit for applying a reaction liquid for increasing viscosity of an ink after contacting the ink onto the ejection receiving medium; an ink applying unit having an inkjet head for forming an ink image on the ejection receiving medium having the reaction liquid applied thereto by applying ink so as to make the applied ink overlap at least part of the region having the reaction liquid applied thereto; a liquid absorbing unit having a first porous body for removing at least part of a liquid component contained in the ink image by contacting with the ink image; and a liquid collecting unit having a second porous body for absorbing the liquid component contained in the first porous body, a pore diameter control system for controlling the pore diameter of the second porous body so as to be firstly made smaller by means of pressure application to the second porous body than the pore diameter of the second porous body prior to the pressure application and subsequently made larger by lowering or releasing the applied pressure than the pore diameter of the second porous body during the pressure application in a state of the second porous body held in contact with the first porous body at the time of absorbing the liquid component contained in the first porous body by means of the second porous body, and a liquid sucking device for sucking and collecting the liquid component contained in the second porous body.

Further features of the present invention will become apparent from the following description of exemplary embodiments with reference to the attached drawings.

### BRIEF DESCRIPTION OF THE DRAWINGS

FIG. 1 is a schematic illustration of an embodiment of the present invention realized in a first mode, which is a transfer type inkjet recording apparatus, showing an exemplar configuration thereof.

FIG. 2 is a schematic illustration of the embodiment of the present invention realized in the second mode, which is a direct drawing type inkjet recording apparatus, showing the configuration thereof.

FIGS. 3A and 3B are schematic cross-sectional views of an exemplar liquid collecting unit that can be used for the embodiment of the present invention.

FIGS. 4A, 4B and 4C are schematic cross-sectional views of another exemplar liquid collecting unit that can be used for the embodiment of the present invention.

FIG. 5 is a schematic cross-sectional view of still another exemplar liquid collecting unit that can be used for the embodiment of the present invention.

FIG. 6 is a schematic cross-sectional view of still another exemplar liquid collecting unit that can be used for the embodiment of the present invention.

FIG. 7 is a block diagram of the control system of the inkjet recording apparatus shown in FIGS. 1 and 2 for controlling the entire inkjet recording apparatus.

FIG. 8 is a block diagram of the printer control section of the transfer type inkjet recording apparatus shown in FIG. 1.

FIG. 9 is an exemplar flow chart of the collecting step of the embodiment of the present invention.

FIG. 10 is a schematic cross-sectional view of still another exemplar liquid collecting unit that can be used for the embodiment of the present invention.

FIG. 11 is a block diagram of the printer control section of the direct drawing type inkjet recording apparatus shown in FIG. 2.

### DESCRIPTION OF THE EMBODIMENTS

Preferred embodiments of the present invention will now be described in detail in accordance with the accompanying drawings.

As a result of the research efforts made by the inventors of the present invention, the inventors of the present invention found that, with the technique described in Japanese Patent Application Laid-Open No. H06-47911, the magnetic fluid that is the liquid absorbed by the superabsorbent resin needs to be collected in a non-operating period. Therefore, if the superabsorbent resin has become full of absorbed liquid during an image recording operation, the ongoing image recording operation has to be suspended in order to collect the absorbed liquid to consequently lower the production yield. With the technique described in Japanese Patent Application Laid-Open No. 2001-179959, on the other hand, if the pore diameter of the absorber is small, the capillary force of the absorber becomes too strong to make it difficult to collect the liquid solvent that has been absorbed by the absorber from the absorber so that the liquid sucking device, which may typically include a suction pump to be used for collecting the liquid solvent is forced to bear a heavy energy load.

Now, the present invention will be described in greater detail by way of preferred embodiments.

An inkjet recording method according to the present invention includes: a step of applying a reaction liquid onto an ejection receiving medium for increasing viscosity of an ink after contacting with the ink; a step of applying the ink so as to make the applied ink overlap at least part of a region having the reaction liquid applied thereto, thereby forming an ink image on the ejection receiving medium; a step of bringing a first porous body into contact with the ink image, thereby removing at least part of a liquid component contained in the ink image; a first collecting step of absorbing the liquid component contained in the first porous body by means of a second porous body; and a second collecting step of sucking and collecting the liquid component contained in the second porous body. The pore diameter of the second porous body is so controlled in the first collecting step as to be firstly made smaller by means of pressure application to the second porous body than the pore diameter of the second porous body prior to the pressure application and subsequently made larger by lowering or releasing the applied pressure than the pore diameter of the second porous body during the pressure application in a state that the second porous body is held in contact with the first porous body. Additionally, the liquid component is collected in the second collecting step in a state that the pore diameter of the second porous body is made larger than the pore diameter of the second porous body during the pressure application in the first collecting step.

An inkjet recording apparatus according to the present invention includes: an ejection receiving medium; a reaction liquid applying unit for applying a reaction liquid for increasing viscosity of an ink after contacting the ink onto the ejection receiving medium; an ink applying unit having an inkjet head for forming an ink image on the ejection receiving medium by applying the ink so as to make the applied ink overlap at least part of a region having the reaction liquid applied thereto; a liquid absorbing unit having a first porous body for removing at least part of a liquid component contained in the ink image by contacting with the ink image; a liquid collecting unit having a second porous body for absorbing the liquid component contained in the first porous body; and a liquid sucking device for sucking and collecting the liquid component absorbed by the second porous body. The liquid collecting unit includes: a pore diameter control system for controlling the pore diameter of the second porous body so as to be firstly made smaller by means of pressure application to the second porous body than the pore diameter of the second porous body prior to the pressure application and subsequently made larger by lowering or releasing the applied pressure than the pore diameter of the second porous body during the pressure application in a state that the second porous body is held in contact with the first porous body at the time of absorbing the liquid component contained in the first porous body by means of the second porous body.

The ink image formed on the ejection receiving medium contains a liquid component. The liquid component is derived from the water and the organic solvent contained in ink and reaction liquid. The first porous body is made to contact the ink image and remove at least part of the liquid component from the ink image in order to suppress the curling and the cockling that arise as the ejection receiving medium, which may typically be paper, excessively absorbs the liquid component. According to the present invention, the liquid component absorbed by the first porous body is then absorbed and collected by the second porous body (the first collecting step). Note that the pore diameter of the second porous body is so controlled as to be made smaller by means of pressure application during the first collecting step. More specifically, the pore diameter at the surface of the second porous body that is brought into contact with the first porous body is so controlled as to be made smaller than the pore diameter of the second porous body prior to the pressure application (in the normal state) by means of pressure application to the second porous body. Thereafter, the pressure application is reduced or released in a state where the second porous body is held in contact with the first porous body. Then, as a result, the pore diameter of the second porous body is increased to give rise to negative pressure in the pores of the second porous body so that the liquid component contained in the first porous body is driven to move into the second porous body. Thus, the second porous body can absorb the liquid component from the first porous body in this way. Additionally, according to the present invention, the liquid component that is absorbed by the second porous body is sucked and collected by means of a liquid sucking device (the second collecting step). Note that, during the second collecting step, the pore diameter of the second porous body is made to be greater than the pore diameter thereof during the pressure application in the first collecting step. Then, as a result, the capillary force of the second porous body can be reduced and hence the energy load that the liquid sucking device, which may typically include a suction pump, has to bear can accordingly be reduced when the liquid sucking device is driven to suck the liquid component from the second porous body.

Now, an embodiment of inkjet recording apparatus according to the present invention will be described below by referring to the drawings.

This embodiment of inkjet recording apparatus may be an inkjet recording apparatus designed to eject ink onto a transfer body, which operates as an ejection receiving medium (ink receiving medium), to form an ink image on the transfer medium and, after absorbing the liquid component from the ink image by means of the first porous body, transfer the ink image onto a recording medium or an inkjet recording apparatus designed to form an ink image on a recording medium, which may typically be paper, cloth or the like, and then suck the liquid component from the ink image on the recording medium by means of the first porous body. Note, here, that, for the purpose of the present invention and for the sake of convenience, the former inkjet recording apparatus is referred to as transfer type inkjet recording apparatus, whereas the latter inkjet etching apparatus is referred to as direction drawing type inkjet recording apparatus.

Now, each of the two types of inkjet recording apparatus will be described in greater detail below.

(Transfer Type Inkjet Recording Apparatus)

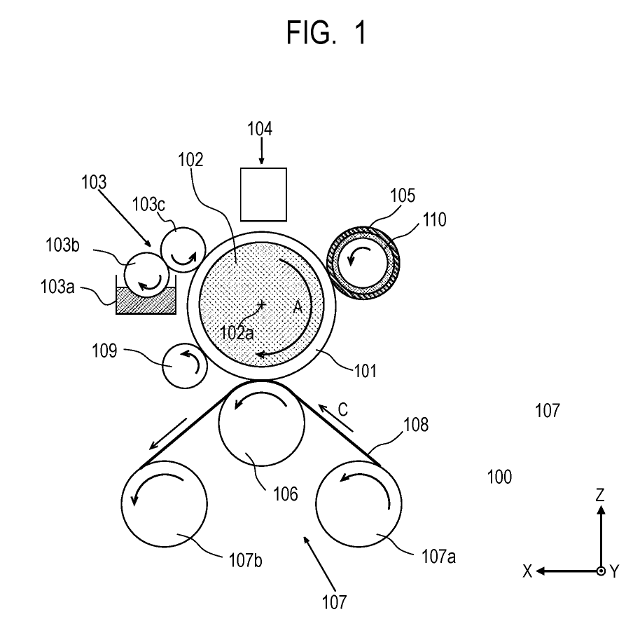

FIG. 1 is a schematic illustration of this embodiment of the present invention realized in a first mode, which is transfer type inkjet recording apparatus 100, showing an exemplar configuration thereof. This recording apparatus is an inkjet recording apparatus designed to produce a record by transferring an ink image onto a recording medium 108 by way of a transfer body 101. In the following description of this embodiment, the X-direction, the Y-direction and the Z-direction respectively refers to the longitudinal (conveying) direction, the width (transversal) direction and the thickness direction of the recording medium 108.

As shown in FIG. 1, the transfer type inkjet recording apparatus 100 of this embodiment includes a transfer body 101, which is an ejection receiving medium, supported by a supporting member 102, a reaction liquid applying unit 103 for applying reaction liquid that reacts with color ink onto the transfer body 101, an ink applying unit 104 for applying color ink to the transfer body 101 having the reaction liquid applied thereto, the ink applying unit 104 having an inkjet head for forming an ink image, which is an image formed by means of one or more inks, on the transfer body 101, a first porous body 105 belonging to a liquid absorbing unit for absorbing the liquid component from the ink image on the transfer body and a pressing member 106 for transferring the ink image on the transfer body 101, from which the liquid component has been removed, onto a recording medium 108, which may typically be paper. If necessary, the transfer type inkjet recording apparatus 100 may further include a transfer body cleaning member 109 for cleaning the surface of the transfer body 101 after transferring the ink image from it. As a matter of course, the transfer body 101, the reaction liquid applying unit 103, the inkjet head of the ink applying unit 104, the first porous body 105 and the transfer body cleaning member 109 have respective lengths in the Y-direction that accommodate the recording medium to be used.

The transfer body 101 is driven to rotate in the sense indicated by arrow A in FIG. 1 around the axis of rotation 102a of the supporting member 102. The transfer body 101 is moved by the rotation of the supporting member 102. Reaction liquid and ink are applied onto the moving transfer body 101 respectively by means of the reaction liquid applying unit 103 and the ink applying unit 104 to form an ink image on the transfer body 101. The ink image formed on the transfer body 101 is then moved further to a position where the roller-shaped first porous body 105 is held in contact with the transfer body 105.

Both the transfer body 101 and the first porous body 105 are moved (rotated) in the sense indicated by the arrow A in synchronism with the rotation of the transfer body 101. The ink image formed on the transfer body 101 is put into a state where it is brought into contact with the moving first porous body 105. During the contact of the ink image and the first porous body 105, the first porous body 105 removes the liquid component from the ink image on the transfer body. In the state where the ink image and the first porous body 105 are held in contact with each other, the first porous body 105 is preferably pressed against the transfer body 101 under predetermined pressure from the viewpoint of effectively operating the first porous body 101.

The removal of the liquid component can be expressed from a different point of view as concentrating the ink constituting the first image formed on the transfer body. Concentrating the ink means that the proportion of the solid content contained in the ink, such as coloring material and resin, with respect to the liquid component contained in the ink increases owing to reduction in the liquid component.

Note, however, that the liquid absorbing unit of an inkjet recording apparatus according to the present invention is not limited to a roller-shaped first porous body. For example, a liquid absorbing unit including a liquid absorbing member having a belt-shaped first porous body, a pressing member for pressing the liquid absorbing member against the ink image on a recording medium and a stretching member for stretching the liquid absorbing member may alternatively be employed.

The ink image from which the liquid component has been removed is accordingly put into a state in which the ink is condensed if compared with the ink of the ink image before the removal of the liquid component and then moved by the transfer body 101 to the transfer section where the ink image is brought into contact with the recording medium 108 that is being conveyed in the direction indicated by arrow C by the recording medium conveyance unit 107. The ink image is transferred onto the recording medium 108 as the pressing member 106 presses the transfer body 101 while the ink image, from which the liquid component has been removed, is held in contact with the recording medium 108. After the image transfer operation, the ink image that has been transferred onto the recording medium 108 is a mirror-reversed image of the ink image before the removal of the liquid component, which is same as the ink image after the removal of the liquid component.

On the other hand, the liquid component that is absorbed by the first porous body 105 is then absorbed by the second porous body 110 that is arranged in the inside of and held in contact with the first porous body 105 (the first collecting step). At this time, the pore diameter of the second porous body 110 is so controlled by the pore diameter control system (not shown) as to become smaller by pressure application to the second porous body than the pore diameter of the second porous body 110 prior to the pressure application (in the normal state). Thereafter, as the pressure application to the second porous body 110 is lowered or released in a state where the second porous body is held in contact with the first porous body 105, the second porous body absorbs the liquid component from the first porous body. Additionally, the liquid component absorbed by the second porous body 110 is sucked and collected by the liquid sucking device (not shown) in a state where the pressure application to the second porous body is lowered or released (the second collecting step). At this time, the pore diameter of the second porous body 110 is brought into a state where it is greater than the pore diameter of the second porous body in the state where pressure is applied to the second porous body (the pore diameter that is controlled so as to become small by the pressure application) in the first collecting step.

Note that, with this embodiment, since reaction liquid is firstly applied onto the transfer body and then ink is applied onto the transfer body to form an ink image, reaction liquid is left without reacting with ink on the non-image region of the transfer body where no ink image is formed with ink. In the inkjet recording apparatus of this embodiment, the first porous body 105 removes the liquid component not only from the ink image but also from the reaction liquid left on the non-image region of the transfer body as it is brought into contact with the reaction liquid that is left without reacting with ink. Therefore, while the expression that the liquid component is removed from the ink image is used in the above description, the expression does not have any limitative meaning that the liquid component is removed only from the ink image but the expression means that the liquid component is removed at least from the ink image on the transfer body as the minimum requirement to be met.

Note that the liquid component is not subject to any particular limitations so long as it does not take any shape, shows fluidity and has a substantially constant volume.

For example, the liquid component may be the water, the organic solvent and so on contained in ink and reaction liquid.

Now, the components of the transfer type inkjet recording apparatus of this embodiment will sequentially be described below.

<Transfer Body>

The transfer body 101 has a surface layer that includes an ink image forming surface. A material showing a high compressive modulus is preferably employed as the material of the surface layer from the viewpoint of durability, although any of various materials including resin materials and ceramic materials may be employed for the surface layer. Specific examples of materials include acrylic resin materials, acrylic silicone resin materials, fluorine-containing resin materials and condensates obtained by condensing hydrolyzable organic silicon compounds. The transfer body 101 may be subjected to a surface treatment for its operation in order to improve the wettability relative to reaction liquid and the image transfer performance and other properties thereof. Surface treatments that can be used include frame processing, corona treatment, plasma treatment, polishing, roughening, active energy ray irradiation, ozone treatment, surfactant treatment and silane coupling treatment. Two or more of the above-described techniques may be used in combination. The surface layer may be made to show any desired surface profile.

The transfer body preferably has a compressible layer that functions to absorb pressure fluctuations. When a compressible layer is provided, it absorbs deformations and disperses local pressure fluctuations to make the transfer body show an excellent transferability even when the transfer body is operated for high speed printing. Examples of materials that can be used for the compressible layer include acrylonitrile-butadiene rubber, acrylic rubber, chloroprene rubber, urethane rubber and silicone rubber. For molding the selected rubber material, preferably, a vulcanizing agent, a vulcanization accelerator or the like is compounded by a predetermined compounding ratio and additionally, if necessary, a filler such as a foaming agent, hollow fine particles, table salt or the like is compounded to make the compressible layer porous. As a result of such an arrangement, the foam part is compressed to change its volume in response to various pressure fluctuations so as to make the transfer body less deformable in all directions except the compressing direction and stably secure the excellent transferability and the excellent durability of the transfer body. Porous rubber materials include those having a continuous pore structure in which the continuous pores are arranged and those having an independent pore structure in which independent pores are arranged. Porous rubber having either of the above structures may be used for the purpose of the present invention. Alternatively, the two structures may be used in combinations.

Preferably, the transfer body has an elastic layer arranged between the surface layer and the compressible layer. Examples of materials that can be used for the elastic layer include resin materials and ceramic materials. Any of these materials can appropriately be used for the purpose of the present invention. A material selected from various elastomer materials and rubber materials may preferably be used for the elastic layer from the viewpoint of desirable processing characteristics. Specific examples of such materials include fluorosilicone rubber, phenyl silicone rubber, fluorine rubber, chloroprene rubber, urethane rubber, nitrile rubber, ethylene propylene rubber, natural rubber, styrene rubber, isoprene rubber, butadiene rubber, ethylene/propylene/butadiene copolymer and nitrile butadiene rubber, of which silicone rubber, fluorosilicone rubber and phenyl silicone rubber are preferable from the viewpoint of dimensional stability and durability because they show the compression set only to a small extent. They are also preferable from the viewpoint that they show only a small change in the modulus of elasticity if the ambient temperature changes and also from the viewpoint of transferability.

Any of various adhesive agents or double sided sticky tapes may be used between the component layers (the surface layer, the elastic layer and the compressible layer) of the transfer body in order to securely maintain the layers in position. One or more reinforcement layers showing a high compressive modulus may be arranged in order to suppress the lateral elongation of any of the layers in the operation of mounting the transfer body in the inkjet recording apparatus and maintain the resilience of the transfer body. Woven fabric may be used for the reinforcement layer or layers. The transfer body can be prepared by appropriately combining the above-described layers formed by using the above-described materials.

The size or dimension of the transfer body can freely and appropriately be selected and determined so as to match the printed images to be formed. The shape of the transfer body is not subject to any particular limitations. As specific examples of the shape of the transfer body, it may be sheet-shaped, roller-shaped, belt-shaped or endless web-shaped.

<Supporting Member>

The transfer body 101 is supported on the supporting member 102. The transfer body 101 may be supported on the supporting member 102 by means of any of various adhesive agents and double-sided sticky tapes. Alternatively, an installation assisting member that is typically made of a metal, ceramic or resin material may be fitted to the transfer body and the transfer body may be supported by the supporting member 102 by way of the installation assisting member.

The supporting member 102 is required to show a certain degree of structural strength from the viewpoint of conveyance accuracy and durability. Preferable materials to be used for the supporting member include metal materials, ceramic materials and resin materials. Particularly preferable materials include aluminum, iron, stainless steel, acetal resin, epoxy resin, polyimide, polyethylene, polyethylene terephthalate, nylon, polyurethane, silica ceramics and alumina ceramics from the viewpoint of rigidity for withstanding the pressure applied thereto during transfer operations, dimensional accuracy and reducing the inertia in operation and improving the control responsiveness. Two or more of the above-listed materials may be used in combination.

<Reaction Liquid Applying Unit>

This embodiment of transfer type inkjet recording apparatus includes a reaction liquid applying unit 103 for applying reaction liquid to the transfer body 101. As reaction liquid is brought into contact with ink, the fluidity of part of the ink and/or the ink composition on the ejection receiving medium is reduced to in turn raise the ink viscosity so that consequently the appearance of the phenomenon of bleeding and that of beading during the image forming operation using ink can be suppressed. More specifically, as the reaction agent (to be also referred to as ink viscosity increasing ingredient) contained in reaction liquid is brought into contact with the coloring material and the resin that are parts of the composition of the ink being used, the reaction agent chemically reacts with the coloring material and the resin or physically adsorbs the coloring material and the resin. Then, as a result, there arises an overall increase of the ink viscosity or a local increase of the ink viscosity due to agglomeration of part of the ink ingredients such as the coloring material to in turn lower the fluidity of part of the ink and/or the ink composition. The reaction liquid applying unit 103 includes a reaction liquid containing section 103a and reaction liquid applying members 103b and 103c for applying the reaction liquid in the reaction liquid containing section 103a onto the transfer body 101.

The reaction liquid applying unit may be any device that can apply reaction liquid onto the ejection receiving medium. In other words, any known device selected from devices of various types that belong to this category can be used. Specific examples of such devices include gravure offset rollers just like the reaction liquid applying unit 103 shown in FIG. 1, inkjet heads, dye coaters and blade coaters. An operation of applying reaction liquid by means of the reaction liquid applying unit is conducted prior to the application of ink. In other words, ink is applied onto the ejection receiving medium onto which reaction liquid has already been applied. As the application of reaction liquid comes prior to the application of ink, the appearance of the phenomenon of bleeding in which inks that are applied at respective positions located side by side are mixed with each other during an image recording operation by means of an inkjet system and also the appearance of the phenomenon of beading in which the ink that lands on the ejection receiving medium earlier is drawn to the ink that lands on the ejection receiving medium later can be suppressed.

<Reaction Liquid>

Now, each of the ingredients of reaction liquid that can be used for this embodiment will be sequentially described in detail below.

(Reaction Agent)

Reaction liquid causes the ingredients having one or more anionic groups (resin, self-dispersing pigment and so on) of the applied ink to aggregate by contacting with ink and contains a reaction agent. Examples of reaction agents that can be used for the purpose of the present invention include polyvalent metal ions, cationic ingredients such as cationic resin and organic acids.

Examples of polyvalent metal ions include divalent metal ions such as Ca²⁺, Cu²⁺, Ni²⁺, Mg²⁺, Sr²⁺, Ba²⁺ and Zn²⁺ and trivalent metal ions such as Fe^{3+,} Cr³⁺, Y³⁺ and Al³⁺ Polyvalent metal salts (including hydrates thereof) that are formed as polyvalent metal ions are bonded to anions can also be used to cause reaction liquid to contain polyvalent metal ions. Examples of anions include inorganic anions such as Cl⁻, Br⁻, I⁻, ClO⁻, ClO₂⁻, ClO₃⁻, ClO₄⁻, NO₂⁻, NO₃⁻, SO₄²⁻, CO₃²⁻, HCO₃⁻, PO₄³⁻, HPO₄²⁻ and H₂PO₄⁻ and organic anions such as HCOO⁻, (COO⁻)₂, COOH(COO⁻), CH₃COO⁻, C₂H₄(COO⁻)₂, C₆H₅COO⁻, C₆H₄(COO⁻)₂ and CH₃SO₃⁻. When a polyvalent metal ion is employed as reaction agent, the content ratio (mass %) of the polyvalent metal ion in the reaction liquid as reduced to polyvalent metal salt is preferably not less than 1.00 mass % and not more than 20.00 mass % relative to the total mass of the reaction liquid.

Reaction liquid containing an organic acid can turn the anionic groups that are an ingredient existing in ink into an acid type and causes them to aggregate as it has a buffering capacity in an acidic region (of less than pH 7.0, preferably of pH between 2.0 and 5.0). Examples of organic acids that can be contained in reaction liquid include monocalboxylic acids such as formic acid, acetic acid, propionic acid, butyric acid, benzoic acid, glycolic acid, lactic acid, salicylic acid, pyrrole carboxylic acid, furan carboxylic acid, picolinic acid, nicotinic acid, thiophene carboxylic acid, levulinic acid and coumalic acid, salts thereof, dicarboxylic acids such as oxalic acid, malonic acid, succinic acid, glutaric acid, adipic acid, maleic acid, fumaric acid, itaconic acid, sebacic acid, phthalic acid, malic acid and tartaric acid, salts and hydrogen salts thereof, tricarboxylic acids such as citric acid and trimellitic acid, salts and hydrogen salts thereof, teteracarboxylic acid such as pyromellitic acid and salts and hydrogen salts thereof. The content ratio (mass %) of the organic acid in reaction liquid is preferably not less than 1.00 mass % and not more than 50.00 mass %.

Examples of cationic resins that can be used for the purpose of the present invention include resins having a primary, secondary or tertiary amine structure and resins having a quaternary ammonium salt structure. More specifically, examples of resins having such structures include resins having a vinyl amine structure, those having an aryl amine structure, those having a vinyl imidazole structure, those having a vinyl pyridine structure, those having a dimethyl amino ethyl methacrylate structure, those having an ethylene imine structure and those having a guanidine structure. A cationic resin and an acidic compound may be used in combination and/or a cationic resin may be subjected to a quaternization process in order to improve the solubility of the cationic resin in reaction liquid. When a cationic resin is employed for reaction liquid, the content ratio of the cationic resin in reaction liquid is preferably not less than 1.00 mass % and not more than 10.00 mass % relative to the total mass of the reaction liquid.

(Ingredients Other than Reaction Agent)

Ingredients other than the reaction agent that can be used for ink include an aqueous medium and one or more other additives similar to those that are pointed out earlier.

<Ink Applying Unit>

This embodiment of inkjet recording apparatus has an ink applying unit 104 for applying ink to the transfer body 101. The ink applying unit 104 applies ink to the transfer body, to which reaction liquid has already been applied, so as to make the applied ink overlap at least part of the surface region of the transfer body where reaction liquid has been applied. Then, the reaction liquid and the ink are mixed with each other on the transfer body and an ink image is formed by the reaction liquid and the ink. Moreover, the liquid component is absorbed from the ink image by the liquid absorbing unit 105.

An inkjet head is employed as the ink applying unit for applying ink in this embodiment. For example, the mode of operation of the inkjet head may be such that ink is ejected by causing ink to give rise to film boiling by means of an electrothermal transducer and thereby forming bubbles, that ink is ejected by means of an electromechanical transducer or that ink is ejected by utilizing static electricity. Any known inkjet head can be used for this embodiment. Particularly, an inkjet head designed to utilize an electrothermal transducer is preferably employed from the viewpoint of high speed and high density printing. As the ink applying unit receives image signals, it applies a required amount of ink to each of the spots that take part in the image drawing operation.

In this embodiment, the inkjet head is a full line head extending in the Y-direction and its nozzles are arranged within a range that covers the entire width of the image recording region of recording mediums of the available largest diameter. The inkjet head has an ink ejection surface at the lower surface thereof (located at the side of the transfer body 1) where nozzles are open. The ink ejection surface is located vis-à-vis the surface of the transfer body with a minute gap (of about several millimeters) interposed between them.

While the amount of ink applied per unit area can be expressed in terms of the density value of the given image data, the thickness of the applied ink or the like, for this embodiment, the amount of ink applied per unit area (g/m²) is expressed by the average value obtained by multiplying the mass of each ink dot by the number of ink application spots and dividing the product of the multiplication by the printed area. The expression of the largest amount of applied ink per unit area of the image region is made to refer to the amount of applied ink per unit area at least in an area not less than 5 mm² within the region to be used for information on the ejection receiving medium from the viewpoint of removing the liquid component in the applied ink.

The ink applying unit 104 may include a plurality of inkjet heads, which are so many ink applying units 104, for the purpose of applying color inks of different colors onto the ejection receiving medium. For example, when yellow ink, magenta ink, cyan ink and black ink are used to form images of the above-listed colors, the ink applying unit 104 is made to include four inkjet heads for ejecting inks of the four different colors on the ejection receiving medium. The four inkjet heads are so arranged as to be aligned in the X-direction.

The ink applying unit may include an inkjet head that ejects clear ink, which is substantially transparent and does not contain any coloring material or, if it contains a coloring material, it contains the coloring material only to a very small proportion. Then, the clear ink may be utilized to form an ink image with reaction liquid and color inks. For instance, such a clear ink can be used to improve the gloss of the drawn image. For this purpose, it is better to appropriately adjust the content ratio of the resin component to be compounded and additionally control the clear ink ejecting position so as to produce gloss on the transferred image. Since the ejected clear ink is preferably located at the surface layer side relative to the color inks on the final record, clear ink is applied to the transfer body 101 before the application of color inks in the case of a transfer type recording apparatus. For this purpose, the inkjet head for ejecting clear ink may be arranged at the upstream side as viewed in the moving direction of the transfer body 101 that is located vis-à-vis the ink applying unit 104 relative to the inkjet heads for ejecting color inks.

Beside the inkjet head for producing gloss, such an inkjet head may be used to improve the performance of transferring an image from the transfer body 101 onto a recording medium. For example, clear ink may be made to contain an ingredient for expressing tackiness more than color inks and applied to the ejected color inks on the transfer body 101. Then, such clear ink can operate as transfer performance improving liquid when applied onto the transfer body 101. For example, the inkjet head for ejecting clear ink for the purpose of improving the image transfer performance may be arranged at the downstream side relative to the inkjet heads for ejecting color inks as viewed in the moving direction of the transfer body 101 that is located vis-à-vis the ink applying unit 104. With this arrangement, after color inks are applied onto the transfer body 101, such clear ink is applied onto the transfer body that is already carrying the color inks applied thereto. Then, the applied clear ink is found on the uppermost surface of the ink image formed on the transfer body 101. The clear ink on the surface of the ink image sticks to the recording medium 108 with a certain degree of adhesive force in the operation of transferring the ink image onto the recording medium at the transfer section so that the ink image can easily be moved onto the recording medium 108 after the removal of reaction liquid.

<Ink>

The ingredients of ink to be used for this embodiment will be described below in detail.

(Coloring Material)

A pigment or a dye can be used as coloring material. The content ratio of the coloring material in ink is preferably not less than 0.5 mass % and not more than 15.0 mass %, more preferably not less than 1.0 mass % and not more than 10.0 mass %, relative to the total mass of ink.

Specific examples of pigments that can be used for ink for the purpose of the present invention include inorganic pigments such as carbon black and titanium oxide and organic pigments such as azo compounds, phthalocyanine, quinacridone, isoindolinone, imidazolone, diketopyrrolopyrrole and dioxazine.

As a technique for dispersing the selected pigment, a resin-dispersed pigment that uses resin as dispersant or a self-dispersing pigment in which a hydrophilic group is bonded to the particle surfaces of the pigment may be employed. Alternatively, a resin-bonded pigment in which a resin-containing organic group is chemically bonded to the particle surfaces of the pigment or a microencapsulated pigment in which the particle surfaces of the pigment are coated with resin or the like may be employed.

As resin-made dispersant for dispersing the pigment in an aqueous medium, a dispersant that can disperse the pigment in an aqueous medium by the action of an anionic group is preferably employed. As resin-made dispersant, preferably the type of resin that will be described hereinafter, more preferably water-soluble resin is employed. The content ratio (mass %) of the pigment is preferably not less than 0.3 times and not more than 10.0 times of the content ratio of the resin-made dispersant in terms of mass ratio (pigment/resin-made dispersant).

As self-dispersing pigment, a pigment in which an anionic group such as a carboxylic acid group, a sulfonic acid group or a phosphonic acid group is bonded to the particle surfaces of the pigment directly or by way of some other group of atoms (—R—) can be employed. The anionic group may be either of the acid type or of the salt type. When the anionic group is of the salt type, it may be either in a partly dissociated state or in a totally dissociated state. Examples of cations that can operate as counter ions when the anionic group is of the salt type include alkali metal cations, ammonium and organic ammonium. Specific examples of some other group of atoms (—R—) include straight chain or branched alkylene groups having one to twelve carbon atoms, arylene groups such as phenylene groups and naphthalene groups, carbonyl groups, imino groups, amido groups, sulfonyl groups, ester groups and ether groups. Any of groups obtained by combining two or more of the above-listed groups may also be employed.

Dyes having an anionic group are preferably used for inks to be used for this embodiment. Specific examples of dyes include azo compounds, triphenylmethane, (aza)phthalocyanine, xanthene and anthrapyridone.

(Resin)

Ink can be made to contain a resin. The content ratio (mass %) of the resin in ink is preferably not less than 0.1 mass % and not more than 20.0 mass %, more preferably not less than 0.5 mass % and not more than 15.0 mass % relative to the total mass of ink.

A resin can be added to ink for the reasons including that (i) the resin stabilizes the dispersed state of the pigment in ink as resin-made dispersant as described above or as an agent for assisting the action of the resin-made dispersant and that (ii) the resin improves various characteristics of the image to be recorded. A resin can be used in the form of block copolymer, in the form of random copolymer, in the form of graft copolymer and so on or in the form of a combination of any of them. The resin to be used may be in a state of being dissolved in an aqueous medium as water-soluble resin or in a state of being dispersed in an aqueous medium as resin particles. Such resin particles may not necessarily encapsulate a coloring material.

For the purpose of the present invention, the expression that a resin is water-soluble means that it does not form particles whose particle diameter can be measured by means of a dynamic light scattering method when the resin is neutralized by alkali equivalent to the acid value. If given resin is water-soluble or not can be determined by means of the method that will be described below. Firstly, liquid containing the resin (solid resin: 10 mass %) that has been neutralized by alkali (sodium hydroxide, potassium hydroxide or the like) that corresponds to the acid value of the resin is prepared. Then, the prepared liquid is diluted with pure water 10 times (in terms of volume) to prepare a sample solution. When the resin particle diameter in the sample solution is measured by a dynamic light scattering method, the resin can be determined to be water-soluble if no particle having a measurable particle diameter is observed. The conditions of the measurement may, for example, be so selected as to include SetZero: 30 seconds, number of times of measurement: 3 and duration of each measurement: 180 seconds. A particle diameter analyzer (e.g., “UPA-EX150”, trade name, available from Nikkiso Co., Ltd.) involving the use of a dynamic light scattering method may be used as particle diameter distribution measuring instrument. Of course, the particle diameter distribution measuring device to be used and the conditions of the measurement are not limited to the above-described ones.

The acid value of the resin to be used is preferably not less than 100 mgKOH/g and not more than 250 mgKOH/g when the resin is a water-soluble resin and not less than 5 mgKOH/g and not more than 100 mgKOH/g when the resin is a particulate resin. The weight average molecular weight of the resin is preferably not less than 3,000 and not more than 15,000 when the resin is water-soluble resin and not less than 1,000 and not more than 2,000,000 when the resin is particulate resin. When the resin particles are measured by means of a dynamic light scattering method (using the conditions of the measurement same as the above-listed ones), the volume average particle diameter thereof is preferably not less than 100 nm and not more than 500 nm.

Resins that can be used in ink for the purpose of the present invention include acryl-based resins, urethane-based resins and olefin-based resins, of which acryl-based resins and urethane-based resins are preferable.

As acryl-based resin, a resin having both a hydrophilic unit and a hydrophobic unit as constituent units is preferable. Above all, an acryl-based resin having a hydrophilic unit that is derived from (meth)acrylic acid and a hydrophobic unit that is derived at least either from a monomer having a benzene ring or from a (meth)acrylate-based monomer is preferable. Particularly, a resin having a hydrophilic unit derived from (meth)acrylic acid and a hydrophobic unit derived at least either from a styrene monomer or from an α-methyl styrene monomer is preferable. Because any of such resins is liable to interact with a pigment, it can suitably be utilized as resin-made dispersant for dispersing a pigment.

A hydrophilic unit has a hydrophilic group such as an anionic group. A hydrophilic unit can typically be formed by polymerizing a hydrophilic monomer having a hydrophilic group. Specific examples of hydrophilic monomers having a hydrophilic group include acidic monomers having a carboxylic acid group such as (meth)acrylic acid, itaconic acid, maleic acid and fumaric acid, anionic monomers that are anhydrates of the above-cited acidic monomers and also anionic monomers that are salts of the above cited acidic monomers. Examples of cations that constitute salts of acidic monomers include ions of lithium, sodium, potassium, ammonium and organic ammonium. A hydrophobic unit is a unit that does not have any hydrophilic group such as an anionic group. A hydrophobic unit can typically be formed by polymerizing a hydrophobic monomer that does not have any hydrophilic group such as an anionic group. Specific examples of hydrophobic monomers include monomers having an aromatic ring such as styrene, α-methylstyrene, benzyl (meth)acrylate and (meth)acrylate-based monomers such as methyl (meth)acrylate, butyl (meth)acrylate and 2-ethylhexyl (meth)acrylate.

Urethane-based resins can be formed, for example, by causing polyisocyanate and polyol to react with each other. A chain extender may be added to the reaction system. Examples of olefin-based resins include polyethylene and polypropylene.

(Aqueous Medium)

Ink may be made to contain water or an aqueous medium, which is a mixture solvent of water and a water-soluble organic solvent. Water to be used for the purpose of the present invention is preferably deionized water or ion-exchange water. The content ratio (mass %) of water in aqueous ink is preferably not less than 50.0 mass % and not more than 95.9 mass % relative to the total mass of ink. The content ratio (mass %) of the water-soluble organic solvent in aqueous ink is preferably not less than 3.0 mass % and not more than 50.0 mass % relative to the total mass of ink. Examples of water-soluble organic solvents include alcohols, (poly)alkylene glycols, glycol ethers, nitrogen-containing compounds, sulfur-containing compounds and other organic solvents that can be used for inks for inkjet applications.

(Other Additives)

In addition to the above-described ingredients, ink can contain various additives selected from anti-foaming agents, surfactants, pH control agents, viscosity modifiers, rust preventing agents, antiseptics, fungicides, antioxidants and anti-reducing agents.

<Liquid Absorbing Unit>

The transfer-type inkjet recording apparatus of this embodiment includes a liquid absorbing unit that absorbs and removes at least part of the liquid component of the ink image formed on the transfer body by means of ink and the reaction liquid by causing the first porous body to contact the ink image. As the liquid component is removed from the ink image by means of the liquid absorbing unit, occurrence of smeared image due to curling, cockling and/or a setoff image appearing on the sheet of paper laid on the proper image can be suppressed. Note that the liquid absorbing unit may be integrally combined with the liquid collecting unit and mounted in the inkjet recording apparatus or, alternatively, mounted in the inkjet recording apparatus as a unit separated from the liquid collecting unit.

For the purpose of the present invention, the liquid absorbing unit is not subject to any particular limitations provided that it has the first porous body. For example, the liquid absorbing unit may be formed by using a roller-shaped first porous body 105 as shown in FIG. 1. Alternatively, the liquid absorbing unit may be formed by using a liquid absorbing member having a belt-shaped first porous body, a pressing member for absorbing liquid that is designed to press the liquid absorbing member against the ink image on the transfer body and a stretching member for stretching the liquid absorbing member.

In addition to the above-described technique of causing the first porous body to contact the ink image, one or more known techniques such as a heating technique, a technique of blowing cool air and a pressure reducing technique may be combined with the proper technique to remove the liquid component from the ink image. Furthermore, after reducing the liquid component of the ink image by causing the first porous body to contact the ink image, any of the above-listed technique may be used to further reduce the liquid component of the ink image. Now, the various components of the liquid absorbing unit and the conditions under which the liquid absorbing unit is to be used in operation will be described below.

(First Porous Body)

For the purpose of the present invention, the first porous body preferably shows a small pore diameter in order to suppress adhesion of the coloring material of ink to the first porous body. More specifically, the pore diameter of the first porous body at the surface thereof that is to be brought into contact with the ink image is preferably not greater than 10 μm. For the purpose of the present invention, the pore diameter refers to the average diameter of the pores, which can be measured by any of the known techniques such as the mercury penetration method, the nitrogen adsorption method and the SEM image observation method.

Additionally, the first porous body preferably has a small thickness in order to show high and uniform gas permeability. The gas permeability can be expressed by a Gurley value as defined in JIS P8117 and the Gurley value of the first porous body is preferably not greater than 10 seconds. However, note that, when the first porous body is made thin, there can arise a situation where the first porous body cannot secure the capacity necessary for satisfactorily absorbing the liquid component. Then, the first porous body can be made to have a multilayer structure to avoid such a situation. The liquid absorbing member may well be such that its layer that is to be brought into contact with the ink image on the transfer body is the first porous body and the layer that is or layers that are not to be brought into contact with the ink image on the transfer body may not be porous.

Now, an embodiment where the porous body is made to have a multilayer structure will be described below. In the following description, the layer that is to be brought into contact with the ink image is referred to as the first layer and the layer that is laid on the surface of the first layer that is opposite to the surface thereof that is to be brought into contact with the ink image is referred to as the second layer. When the porous body has more layers, they will be tagged with cardinal numbers sequentially from the first layer.

(First Layer)

For the purpose of the present invention, the material of the first layer is not subject to any particular limitations, although it is preferably fluorine-containing resin showing a low surface free energy level from the viewpoint of suppressing the adhesion of coloring materials thereto and raising the cleanability thereof. Specific examples of fluorine-containing resin that can be used for the first layer include polytetrafluoroethylene (PTFE), polychlorotrifluoroethylene (PCTFE), polyvinylidene fluoride (PVDF), polyvinyl fluoride (PVF), perfluoroalkoxy fluorine-containing resin (PFA), fluorinated ethylene-propylene copolymer (FEP), ethylene-tetrafluoroethylene copolymer (ETFE) and ethylene-chlorotrifluoroethylene copolymer (ECTFE). One or more such resins can be used to meet the requirements of the first layer. The first layer may be made to show a multilayer structure.

The thickness of the first layer is preferably not more than 50 μm, more preferably not more than 30 μm. For the purpose of the present invention, the thickness of the first layer is the value obtained by measuring the thickness at randomly selected ten points by means of a straight type micrometer OMV_25 (trade name, available from Mitsutoyo) and determining the average value of the measurement values.

(Second Layer)

For the purpose of the present invention, the second layer is preferably a layer showing gas permeability. For example, the second layer may be made of non-woven fabric or woven fabric. While the material of the second layer is not subject to any particular limitations, a single material such as polyolefin (polyethylene (PE), polypropylene (PP) etc.), polyurethane, nylon, polyamide, polyester (polyethyleneterephthalate (PET) etc.), polysulfone (PSF) or the like or a composite material obtained by using any of the above-listed single materials is preferable.

(Third Layer)

The third layer is preferably made of non-woven fabric from the viewpoint of rigidity. Materials that can be used for the second layer can also be used for the third layer.

(Method of Manufacturing First Porous Body)

When the first porous body is formed by laying the second layer on the first layer, the method of manufacturing the first porous body is not subject to any particular limitations. In other words, the second layer may simply be laid on the first layer or it may be bonded to the first layer by means of the technique of adhesive lamination or thermal lamination. Above all, the use of the thermal lamination technique of pinching the first layer and the second layer by means of a pair of heated rollers and applying heat to the first and second layers, while also applying pressure to them, is preferable from the viewpoint of securing gas permeability. Alternatively, the first layer and the second layer may be bonded after melting part of the first layer or the second layer by heat. Still alternatively, a fusion bonding agent such as hot melt powder may be interposed between the first layer and the second layer and the two layers may be bonded to each other by heating. When three or more layers are to be laminated, they may be bonded to each other at once or sequentially one on the other. The order of laying three or more layers may appropriately be determined.

(Pressurizing Conditions)

When the first porous body is brought into contact with the ink image on the transfer body, the pressure of the first porous body is preferably not less than 2.9 N/cm² (0.3 kgf/cm²) because, with such a pressure level, solid-liquid separation can be made to take place in the ink image with ease in a short period of time to remove the liquid component of the ink image. The expression of the pressure of the first porous body refers to the nip pressure between the transfer body 101 and the first porous body 105. It is the value obtained by conducting a surface pressure measurement by means of a surface pressure distribution measuring instrument (I-SCAN: trade name, available from Nitta) and dividing the load in the pressurized region by the area of the region.

(Duration of Operation)

The duration of operation of holding the first porous body in contact with the ink image is preferably not more than 50 ms from the viewpoint of further suppressing the adhesion of the coloring material in the ink image to the first porous body. The expression of duration of operation for the purpose of the present invention is the value obtained by dividing the pressure sensing width as viewed in the moving direction of the transfer body 101 by the moving speed of the transfer body 101 in the above-described surface pressure measurement. In the following description, the duration of operation is referred to as liquid absorption nip time.

<Liquid Collecting Unit>

The transfer type inkjet recording apparatus of this embodiment includes a liquid collecting unit for collecting the liquid component contained in the first porous body. Firstly, the liquid component contained in the first porous body is absorbed by bringing the second porous body into contact with the first porous body (the first collecting step). At this time, this contact operation is so controlled by pressure application as to make the pore diameter of the second porous body smaller than the pore diameter of the second porous body before the pressure application and, thereafter, the pressure application is reduced or released in a state where the second porous body is held in contact with the first porous body. Then, as a result, the pore diameter of the second porous body is increased to give rise to negative pressure in the pores of the second porous body. Thus, the second porous body absorbs and collects the liquid component in the first porous body. Then, the liquid component contained in the second porous body is absorbed and collected by means of the liquid sucking device having a suction pump or the like (the second collecting step). Note that the liquid component in the second porous body is sucked and collected from the second porous body in a state where the pore diameter of the second porous body is made larger than the pore diameter of the second porous body during the pressure application in the first collecting step (the pore diameter when the pore diameter is so controlled as to become small by the pressure application). Since the pore diameter of the second porous body is now made greater than the pore diameter of the second porous body during the above-described pressure application, the capillary force of the second porous body falls from the level observed during the pressure application in the first collecting step. Under this condition, negative pressure is produced by the liquid sucking device so that the liquid component can efficiently be collected from the second porous body.

The position of the second porous body relative to the first porous body is not subject to any particular limitations. For example, as shown in FIG. 1, the second porous body 110 may be arranged so as contact the inside of the roller-shaped first porous body 105. Alternatively, the second porous body may be arranged at a position located vis-à-vis the surface of the first porous body that is to be brought into contact with the ink image. The first porous body and the second porous body may be integrally formed or formed as separate entities. When the first porous body and the second porous body are formed integrally, the pore diameter of the integrally formed first and second porous bodies may be made to increase from the first porous body toward the second porous body.

The pore diameter of the second porous body can be changed by pressure application. For example, the second porous body is preferably formed by using an elastic body to make the pore diameter of the second porous body small by pressure application by means of a pore diameter control system. The hardness of the second porous body is preferably between 15° and 80° when proved as a result of a test using a durometer Type D spring-loaded that conforms to JIS K6253. When the hardness is not less than 15°, if the second porous body is deformed as a result of pressure application, it can easily restore its original shape. When the hardness is not more than 80°, the second porous body can easily be compression-deformed by pressure application. Therefore, for example, when the second porous body is a roller-shaped rotating body, the resistance that arises due to rotation of the second porous body can be suppressed to in turn reduce the vibrations of the second porous body.

Materials that can be used for the second porous body include PTFE, FEP, FFA, PCTFE, PVDF, ethylene-vinyl acetate copolymer (EVA), polyvinyl alcohol (PVA), polyethylene (PE), polypropylene (PP), cross-linked sodium polyacrylate and starch-polyacrylonitrile hydrolyzate. Each of the above-listed materials can be turned into a porous state by means of a method suited for the material that can be selected from the cast method, press processing, high frequency discharge, arc discharge, extension, the irradiation etching method, the thermally induced phase separation method and so on. A surface treatment operation may be executed on the prepared porous body so as to make it express the hydrophilic property and the hydrophobic property thereof. As for the shape of the second porous body, it may be roller-shaped or belt-shaped among others.

Pressure application by means of air or by means of a blade may be adopted as technique for reducing the pore diameter of the second porous body under control by pressure application. The operation of pressure application is executed on the second porous body in the first collecting step of absorbing the liquid component from the first porous body into the second porous body. As the pore diameter of the second porous body is reduced as a result of the pressure application, the capillary force of the second porous body increases. Therefore, the spontaneous penetration of the liquid component into the second porous body can be promoted by the increased capillary force of the second porous body. For this reason, in the first collecting step, the pore diameter of the second porous body in the state where the second porous body is brought into contact with the first porous body is preferably smaller than the above-described pore diameter of the first porous body. Besides, the pore diameter of the first porous body is preferably not less than 0.2 μm and not more than 10 μm. When the first porous body has a plurality of layers, the pore diameter of the layer that is to be brought into contact with the second porous body is preferably not less than 0.2 μm and not more than 20 μm. The pore diameter of the first porous body is preferably not changed by the pressure application. As the pressure application is reduced or released, the pore diameter of the second porous body is increased to give rise to negative pressure in the pores thereof so that the second porous body can satisfactorily absorb and collect the liquid component. For the purpose of amplifying the negative pressure in the pores of the second porous body, the pore diameter of the second porous body is preferably so controlled as to be made greater by releasing the pressure application in the first collecting step than the pore diameter observed during the pressure application. In the second collecting step of sucking and collecting the liquid component from the second porous body, it is sufficient for the pore diameter of the second porous body that it is greater in the second collecting step of sucking and collecting the liquid component from the second porous body than the pore diameter observed during the pressure application in the first collecting step. For example, the state where the pressure application is released from the second porous body may be maintained. Then, as a result, the pore diameter of the second porous body is held to be the same as before the pressure application (in the normal state) so that the pore diameter is brought into a state of being greater than the pore diameter in the first collecting step. Since the capillary force of the second porous body can be reduced, the energy load of the liquid sucking device can be reduced during the operation of sucking and collecting the liquid component. The pore diameter of the second porous body prior to the pressure application in the first collecting step is preferably not less than 0.5 μm and not more than 30 μm. The pore diameter of the second porous body during the pressure application in the first collecting step is preferably not less than 0.1 μm and not more than 10 μm. Additionally, the pore diameter of the second porous body in the second collecting step is preferably not less than 1 μm and not more than 30 μm. Note that, when the pore diameter of the second porous body is so controlled as to be made small by means of pressure application, the porosity of the second porous body is preferably greater than the porosity of the first porous body because the volumetric capacity of containing the liquid component of the second porous body is also reduced by the pressure application.

On/off control of the operation of pressure application may be executed intermittently according to a predetermined time schedule or by forecasting the quantity of the liquid component to be absorbed by the first porous body according to the given printing data. The liquid component can be collected more efficiently by accurately knowing the amount of the liquid component absorbed by the second porous body for on/off control of the operation of pressure application. More specifically, the operation of pressure application can be controlled by arranging a pressure gauge or a flow meter between the second porous body and the suction pump, estimating the amount of the liquid component that has been absorbed by the second porous body on the basis of the observed reading and linking the on/off control with the estimated amount. Alternatively, it is possible to know the absorbed amount of the liquid component by seeing the change in the mass of the first porous body. More specifically, the first porous body may be made to show a roller-shaped profile and a torque sensor may be fitted to the rotary shaft of the roller so as to estimate the amount of the liquid component absorbed by the first porous body on the basis of the observed reading of the detector and link the on/off control of the operation of pressure application with the estimated amount of the absorbed liquid component.

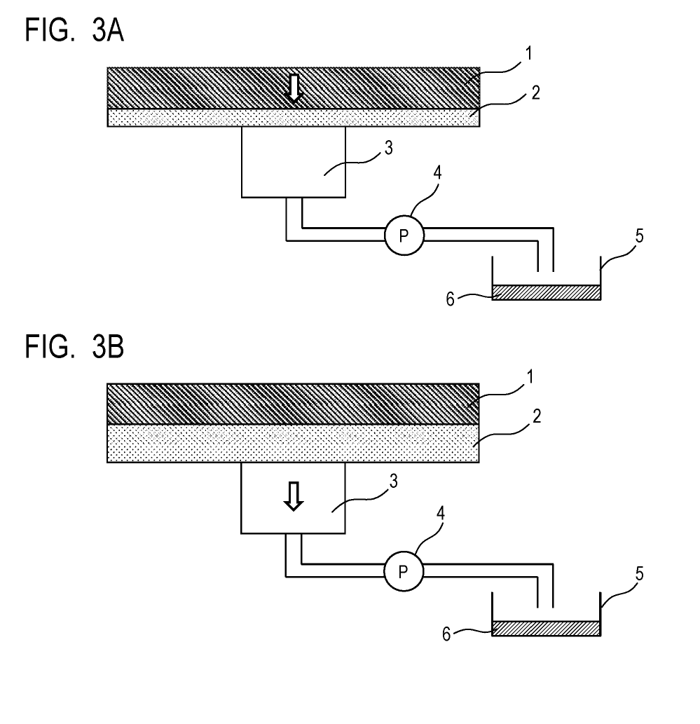

FIGS. 3A and 3B are schematic cross-sectional views of an exemplar liquid collecting unit that can be used for this embodiment. More specifically, FIGS. 3A and 3B are schematic enlarged cross-sectional views of the site where the second porous body 2 contacts the opening 3 of the liquid collecting unit and its vicinity. The liquid collecting unit shown in FIGS. 3A and 3B includes the second porous body 2 that is arranged so as to contact the inside of the roller-shaped first porous body 1, the opening 3 held in contact with the inside of the second porous body 2 so as to suck and collect the liquid component, the suction pump 4 held in communication with the opening 3 to generate suction power by negative pressure and the liquid component storage tank 5 for storing the collected liquid component 6.

In the first collecting step shown in FIG. 3A, the second porous body 2 is compressed (by pressure application) to reduce the pore diameter of the second porous body 2 and cause the liquid component absorbed by the first porous body 1 to spontaneously penetrate by capillary force into the second porous body 2 and subsequently the compression (the pressure application) is released so as allow the liquid component to be absorbed by negative pressure. In the second collecting step shown in FIG. 3B, the liquid component is sucked and collected from the second porous body 2 by means of the suction pump 4 in the state where the compression of the second porous body 2 is released. This arrangement can reduce the energy load of the suction pump 4. The part of the liquid collecting unit where the opening 3 contacts the second porous body 2 can be formed as a rubber-like elastic member. As the part of the liquid collecting unit that is held in contact with the second porous body 2 is formed by using a soft and resilient member, the opening 3 can be held in tight contact with the second porous body 2 to reduce the load that is applied to the second porous body 2 during the operation of collecting the liquid component from the second porous body 2. Note that opening 3 may completely cover the second porous body in the longitudinal direction of the second porous body. Additionally, the opening 3 may be so arranged as to be movable in the direction of the shaft of the roller (the longitudinal direction of the roller). Then, the liquid collecting unit can collect the liquid component from the second porous body by moving the opening 3 in the longitudinal direction of the second porous body 2.

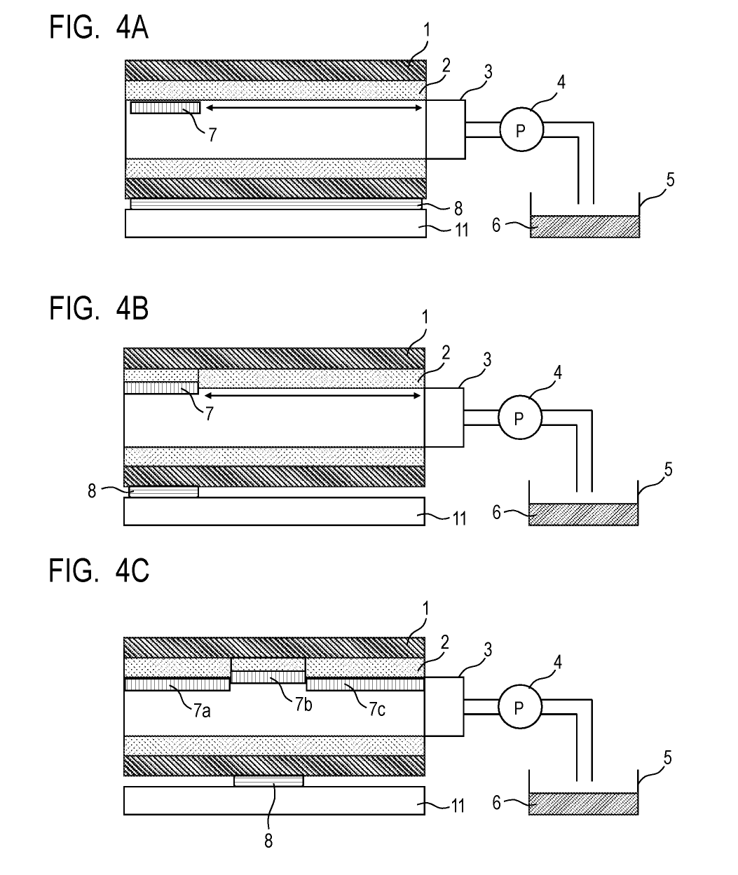

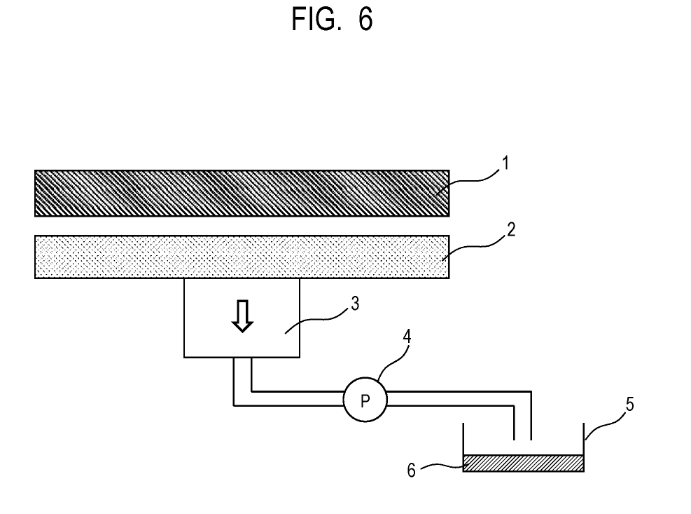

FIGS. 4A, 4B and 4C are schematic cross-sectional views of another exemplar liquid collecting unit that can be used for this embodiment. With the liquid collecting unit shown in FIGS. 4A and 4B, the second porous body 2 is arranged so as to contact the inside of the roller-shaped first porous body 1. The opening 3 is arranged at a center part of the roller shaft to suck and collect the liquid component and the liquid component is sucked by means of suction pump 4 that is held in communication with the opening 3 and stored in the liquid component storage tank 5. In FIGS. 4A through 4C, 6 denotes the collected liquid component. The pore diameter of the second porous body 2 can be changed by causing a blade 7 to contact the second porous body 2 and applying pressure to it in the direction toward the first porous body and the second porous body.

With the liquid collecting unit shown in FIG. 4A, the contact position of the blade 7 relative to the second porous body 2 can be moved in the direction of the roller shaft (in the longitudinal direction of the roller). For this reason, if the ink image 8 extends across the entire width of the ejection receiving medium 11, the movable type blade 7 can be made to scan the entire length of the roller shaft for the purpose of collecting the liquid component. Alternatively, as shown in FIG. 4B, the blade 7 may be moved under control so as to correspond to the position where the ink image 8 exists on the ejection receiving medium 11 in order to intensively collect the liquid component according to the position of the ink image. Then, the operation of controlling the position of the blade 7 needs to be linked with the given image data. Still alternatively, as shown in FIG. 4C, the blade may be divided into a plurality of parts (7a, 7b and 7c) in the longitudinal direction of the roller shaft and the blade part that corresponds to the position where the ink image 8 exists on the ejection receiving medium 11 (blade part 7b in FIG. 4C) is made to contact the second porous body 2. As described above, the blade part to be used for pressure application may appropriately be selected under control by making the selection of the blade part to be linked with the given image data in order to intensively collect the liquid component according to the position of the ink image.

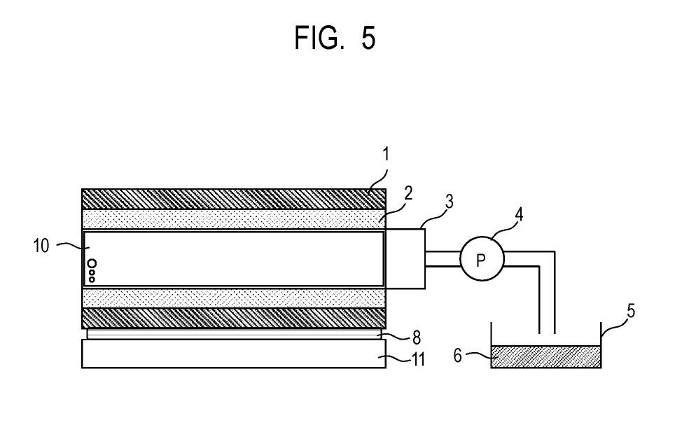

FIG. 5 is a schematic cross-sectional view of still another exemplar liquid collecting unit that can be used for this embodiment. The liquid collecting unit shown in FIG. 5 is similar to the one shown in FIGS. 4A through 4C except the pore diameter control system. The liquid collecting unit shown in FIG. 5 includes an air bag 10 arranged in the inside of the second porous body 2. The air bag 10 is inflated by introducing air into the air bag 10 through an air inlet port (not shown) and caused to contact the inside of the second porous body to apply pressure to the second porous body 2 and change the pore diameter of the second porous body 2 by means of the pressure application of air. When the air bag 10 is employed for the purpose of pressure application, the air bag 10 may be divided into a plurality of parts in the direction of the roller shaft (in the longitudinal direction of the roller) and only the air bag part that is located at the position corresponding to the position where the ink image 8 exists on the ejection receiving medium 11 may be made to contact the second porous body 2. With this arrangement, the air bag part to be used for pressure application may appropriately be selected under control so as to make the selection of the air bag to be linked with the given image data in order to intensively collect the liquid component according to the position of the ink image.

FIG. 6 is a schematic cross-sectional view of still another exemplar liquid collecting unit that can be used for this embodiment. The liquid collecting unit shown in FIG. 6 is similar to the liquid collecting unit shown in FIGS. 3A and 3B except that the first porous body 1 and the second porous body 2 can be separated from each other so as not to contact each other in the second collecting step. When the pore diameter of the second porous body 2 is so controlled as to make it greater in the second collecting step than in the first collecting step typically by maintaining the state where the second porous body 2 is released from the pressure application, it may be conceivable that an instance where the capillary force of the first porous body 1 becomes greater than the capillary force of the second porous body 2 occurs. However, because the first porous body 1 and the second porous body 2 do not contact each other in the second collecting step, the phenomenon that part of the liquid component collected by the second porous body 2 flows back to the first porous body 1 can be prevented from taking place.

The capillary force F1 of the first porous body in the first collecting step, the capillary force F2 of the second porous body in the first collecting step and the capillary force F3 of the second porous body in the second collecting step can respectively be expressed by formulae (a), (b) and (c) shown below.

F1(kPa)=γs1 cos θ1/d1 (a)

F2(kPa)=γs2 cos θ2/d2′ (b)

F3(kPa)=γs2 cos θ2/d2 (c)

Where γs1(mN/m) represents the surface fee energy of the first porous body; d1(μm) represents the pore diameter of the first porous body; θ1(°) represents the contact angle of the first porous body relative to the ink contacting it, γs1, d1 and θ1 respectively represent the surface free energy, the pore diameter and the contact angle relative to the ink contacting it at the surface of the first porous body that is held in contact with the second porous body, γs2 (mN/m) represents the surface free energy of the second porous body, d2′(μm) represents the pore diameter (controlled so as to be held small) of the second porous body during the pressure application in the first collecting step, d2(μm) represents the pore diameter prior to the pressure application (in the normal state, not controlled so as to be held small) of the second porous body, θ2(°) represents the contact angle of the second porous body relative to the ink contacting it, and γs2, d2′ and d2 and θ2 respectively represent the surface free energy, the pore diameters and the contact angle relative to the ink contacting it at the surface of the second porous body held in contact with the first porous body.

In the second collecting step, preferably, the pore diameter of the second porous body is controlled so as to be held small and so as for d2′ to satisfy the requirement of F1<F2, namely the requirements of formula (1) shown below by the pressure application.

γs1 cos θ1/d1<γs2 cos θ2/d2′ (1)

When the above-described requirement is satisfied, the capillary force of the second porous body is greater than the capillary force of the first porous body in the first collecting step and hence the liquid component can be made to spontaneously penetrate into the second porous body from the first porous body due to the capillary force of the second porous body. Note that the surface free energy can be computationally determined by measuring the contact angle and using the Kitazaki-Hata equation.

Additionally, as the pore diameter of the second porous body is made to be equal to d2 in the second collecting step, F3<F2 is made to hold true. In other words, the capillary force of the second porous body is reduced. Then, as a result, the energy load of the liquid collecting unit, which may typically be a suction pump, can be reduced in the operation of sucking and collecting the liquid component from the second porous body. Particularly, the requirement of F3<F1 is preferably satisfied from the viewpoint of reducing the energy load of the liquid collecting unit.

<Pressing Member for Image Transfer>

With this embodiment, after removing liquid from the ink image on the transfer body 101, the ink image is transferred onto the recording medium 108 conveyed to the transfer body 101 by the recording medium conveyance unit 107 by causing the ink image to contact the recording medium 108 by means of the pressing member 106 for image transfer. As the ink image is transferred onto the recording medium 108 after removing the liquid component contained in the ink image on the transfer body 101, it becomes possible to obtain a recorded image where the phenomenon of curling and that of cockling are suppressed.

The pressing member 106 is required to show a certain degree of structure strength from the viewpoint of accuracy of conveying the recording medium 108 and durability of the pressing member 106. Preferable materials that can be used for the pressing member 106 include metal, ceramic and resin. In particular, from the viewpoint of reducing the inertia in operation and improving the responsiveness of control operations in addition to the rigidity for withstanding the applied pressure during the image transfer operation and dimensional accuracy, preferable materials for the pressing member 106 include aluminum, iron, stainless steel, acetal resin, epoxy resin, polyimide, polyethylene, polyethylene terephthalate, nylon, polyurethane, silica ceramic and alumina ceramic. Any two or more of the above-listed materials may be used in combination.

While the duration of the pressing operation of pressing the transfer body by means of the pressing member 106 for transferring the ink image on the transfer body 101 onto the recording medium 108 after removing liquid from the ink image is not subject to any particular limitations, it is preferably not less than 5 ms and not more than 100 ms in order to satisfactorily execute the image transfer operation without damaging the durability of the transfer body. For the purpose of this embodiment, the duration of the pressing operation refers to the duration of time by which the recording medium 108 is held in contact with the transfer body 101. More specifically, the duration of the pressing operation is computationally determined by measuring the surface pressure by means of a surface pressure distribution measuring instrument (I-SCAN: trade name, available from Nitta) and dividing the length of the pressurized region in the transfer direction by the transfer speed.

While the pressure to be applied by the pressing member 106 to the transfer body 101 in order to transfer the ink image on the transfer body 101 onto the recording medium 108 after removing liquid from the ink image is not subject to any particular limitations, the applied pressure needs to be such that the transfer operation is executed satisfactorily and the durability of the transfer body is not damaged. For this purpose, the applied pressure is preferably not less than 9.8 N/cm² (1 kg/cm²) and not more than 294.2 N/cm² (30 kg/cm²). For the purpose of this embodiment, the pressure refers to the nip pressure between the recording medium 108 and the transfer body 101 as determined by measuring the surface pressure by means of a surface pressure distribution measuring instrument and dividing the load in the pressurized region by the area of the region.

While the temperature at which the pressing member 106 applies pressure to the transfer body 101 in order to transfer the ink image on the transfer body 101 onto the recording medium 108 after removing liquid from the ink image is not subject to particular limitations, it is preferably not lower than the glass transition point or the softening point of the resin component contained in the ink. Additionally, in terms of the mode of heating, the inkjet recording apparatus is preferably provided with a heating means for heating the ink image on the transfer body 101, from which liquid has been removed, the transfer body 101 and the recording medium 108.

While the shape of the pressing member 106 is not subject to particular limitations, it may typically be roller-shaped.

<Recording Medium and Recording Medium Conveyance Unit>

The recording medium 108 to be used for this embodiment is not subject to any particular limitations and any known recording medium can be used for this embodiment. Known recording mediums include wound rolls of long recording mediums and sheets of recording mediums cut to predetermined dimensions. The materials of recording mediums to be used for this embodiment include paper, plastic film, wooden boards, cardboard and metal film.

While the recording medium conveyance unit 107 for conveying the recording medium 108 shown in FIG. 1 is formed by using a recording medium feed roller 107a and a recording medium take-up roller 107b, the only requirement that the recording medium conveyance unit 107 is to satisfy is that it can convey a recording medium and the formation of the recording medium conveyance unit 107 is not limited to the one shown in FIG. 1.

<Control System>

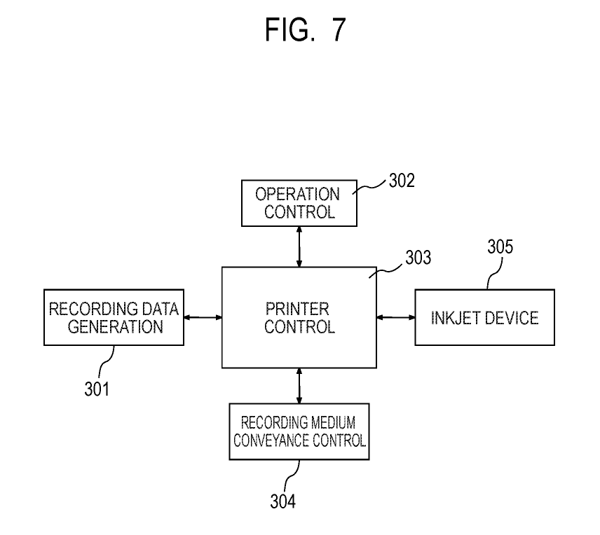

The transfer type inkjet recording apparatus of this embodiment includes a control system for controlling the component units thereof. FIG. 7 is a block diagram of the control system of the entire transfer type inkjet recording apparatus shown in FIG. 1.

In FIG. 7, 301 denotes a recording data generation section, which may typically be an external print server, 302 denotes an operation control section, which may typically be an operation panel, 303 denotes a printer control section for executing a recording process, 304 denotes a recording medium conveyance control section for conveying a recording medium and 305 denotes an inkjet device for printing operations.

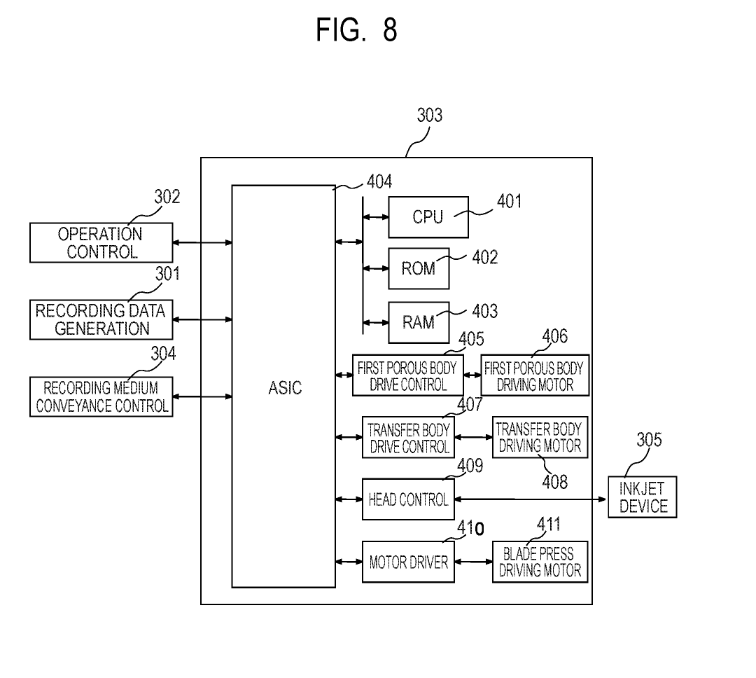

FIG. 8 is a block diagram of the printer control section of the transfer type inkjet recording apparatus shown in FIG. 1.

In FIG. 8, 401 denotes a CPU for controlling the entire printer, 402 denotes a ROM for storing the control program of the CPU 401 and 403 denotes a RAM to be used for executing the control program. 404 denotes an application specific integrated circuit (ASIC) containing a network controller, a serial IF controller, an inkjet head data generation controller and a motor controller among others. 405 denotes a first porous body drive control section for driving first porous body driving motor 406, which is command-controlled from the ASIC 404 by way of a serial IF. 407 denotes a transfer body drive control section for driving transfer body driving motor 408, which is also command-controlled from the ASIC 404 by way of the serial IF. 409 denotes an inkjet head control section that operates for generation of final ejection data of the inkjet device 305 and generation of the drive voltage among others. 410 denotes a motor driver for driving blade press driving motor 411, which is also command-controlled from the ASIC 404 by way of the serial IF.

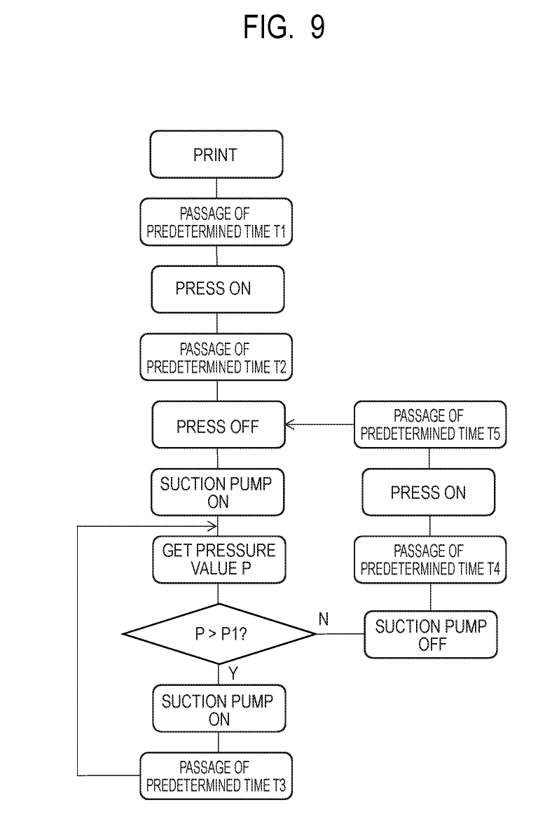

FIG. 9 is an exemplar flow chart of the collecting step of this embodiment of the present invention. According to the flow chart shown in FIG. 9, a pressure gauge is arranged between the second porous body and the suction pump and the amount of the liquid component absorbed into the second porous body is estimated on the basis of the reading (pressure value) of the pressure gauge. Then, on/off control of the pressure application and also on/off control of the suction pump are linked with the estimated amount of the absorbed liquid component. As it is confirmed that predetermined time T1 has elapsed since the start of a printing operation, the pressure application is turned on and the liquid component is collected from the first porous body to the second porous body. Then, as it is confirmed that predetermined time T2 has elapsed since the start of the pressure application, the pressure application is turned off.

Then, as the suction pump is turned on, the liquid component is collected from the second porous body and the pressure value P is obtained at the same time. The pressure value P is compared with predetermined pressure value P1 and if the pressure value P exceeds P1, the suction pump is held on. Then, it is confirmed that predetermined time T3 has elapsed since the start of the operation of the suction pump. After the elapse of the predetermined time T3, the pressure value P is obtained once again. As long as the obtained pressure value P exceeds the predetermined pressure value P1, the operation of driving the suction pump is kept on.

When, on the other hand, the pressure value P is compared with P1 and it is found that the pressure value P has become not higher than P1, the suction pump is turned off and then it is confirmed that predetermined time T4 has elapsed. As the predetermined time T4 has elapsed, the pressure application is turned on once again and then it is confirmed that predetermined time T5 has elapsed. Then, the pressure application is turned off and the liquid component is collected under control to follow the flow chart in a manner as described above.

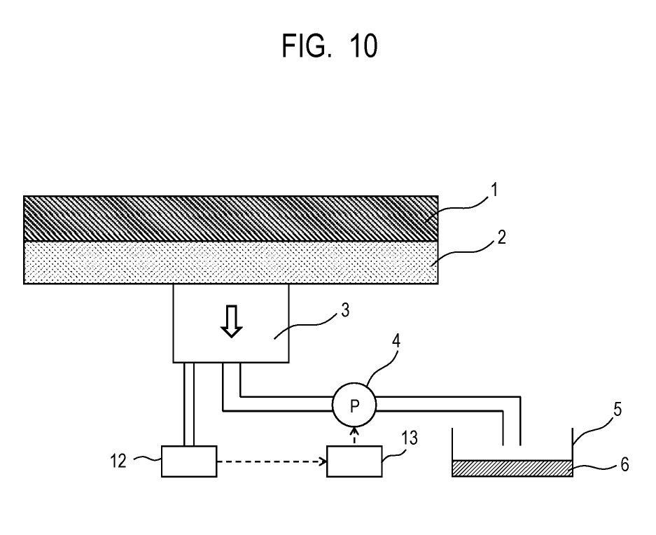

FIG. 10 is a schematic cross-sectional view of still another exemplar liquid collecting unit that can be used for this embodiment. Note that the liquid collecting unit shown in FIG. 10 is similar to the liquid collecting unit shown in FIG. 3B except that it additionally includes a pressure gauge 12 and a pump controller 13 arranged between the second porous body 2 and the opening 3 of the suction pump 4. The pressure at the time of sucking and collecting the liquid component from the second porous body 2 is observed by means of the pressure gauge 12 and the pump controller 13 operates for on/off control of the suction pump 4 according to the reading of the pressure gauge 12. The on/off control operation for the pressure application may be started after the elapse of a predetermined time that is observed by a time counter.

(Direct Drawing Type Inkjet Recording Apparatus)

This embodiment may be realized as a direct drawing type inkjet recording apparatus. For direct drawing type inkjet recording apparatus, the ejection receiving medium is the recording medium on which an image is to be formed.

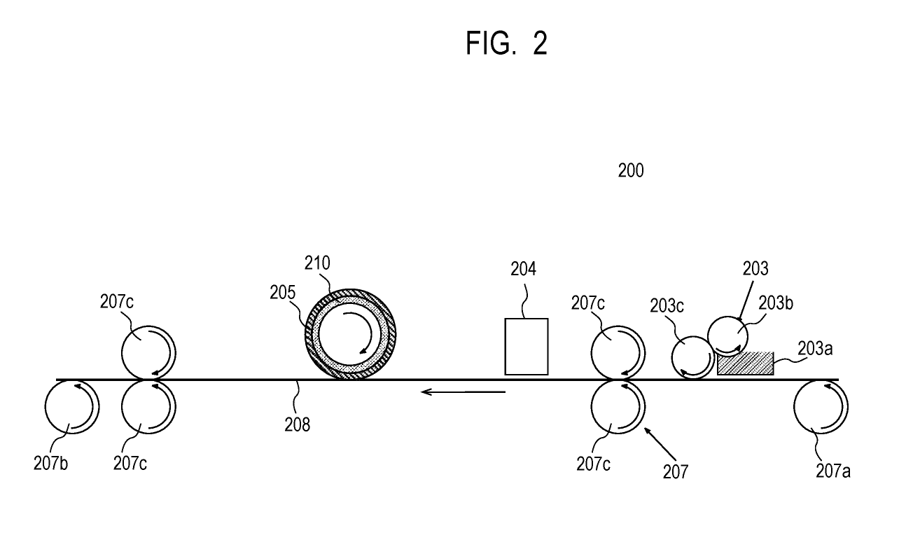

FIG. 2 is a schematic illustration of the direct drawing type inkjet recording apparatus of this embodiment, showing the configuration thereof. When compared with the above-described transfer type inkjet recording apparatus, this direct drawing type inkjet recording apparatus has a configuration similar to the configuration of the transfer type inkjet recording apparatus except that it does not include a transfer body 101, a supporting member 102 and a transfer body cleaning member 109 and directly forms an image on a recording medium 208.

Therefore, the reaction liquid applying unit 203 (including the reaction liquid containing section 203a and the reaction liquid applying members 203b and 203c) for applying reaction liquid to the recording medium 208, the ink applying unit 204 for applying ink to the recording medium 208, the first porous body 205, which is a liquid absorbing unit for contacting the ink image on the recording medium 208 and absorbing the liquid component contained in the ink image, and the second porous body 210 for contacting the first porous body 205 and collecting the liquid component are structurally the same as their counterparts of the transfer type inkjet recording apparatus and hence will not be described here any further.

Note that, in this direct drawing type inkjet recording apparatus again, the liquid absorbing unit is not limited to a roller-shaped first porous body. The liquid absorbing unit may include a liquid absorbing member having a belt-shaped first porous body, a pressing member for pressing the liquid absorbing member against the ink image on the recording medium and a stretching member for stretching the liquid absorbing member.

Additionally, a recording medium supporting member (not shown) for supporting the recording medium from under may be provided for the ink applying section for applying ink to the recording medium 208 by means of the ink applying unit 204 and also for the liquid component removing section for causing the first porous body 205 to contact the ink image on the recording medium and removing the liquid component.

<Recording Medium Conveyance Unit>

The recording medium conveyance unit 207 of the direct drawing type inkjet recording apparatus of this embodiment is not subject to any particular limitations and a conveyor device of any known direct drawing type inkjet recording apparatus may also be employed for this embodiment. As an example, a recording medium conveyance unit having a recording medium feed roller 207a, a recording medium take-up roller 207b and pairs of recording medium conveying rollers 207c as shown in FIG. 2 may be employed. If necessary, the number and the positions of pairs of recording medium conveying rollers 207c may appropriately be adjusted.

<Control System>

The direct drawing type inkjet recording apparatus of this embodiment has a control system for controlling each of the component units. The block diagram of the control section of the control system shown in FIG. 7 and described above for the transfer type inkjet recording apparatus shown in FIG. 1 is also applicable to the control system of the direct drawing type inkjet recording apparatus shown in FIG. 2.

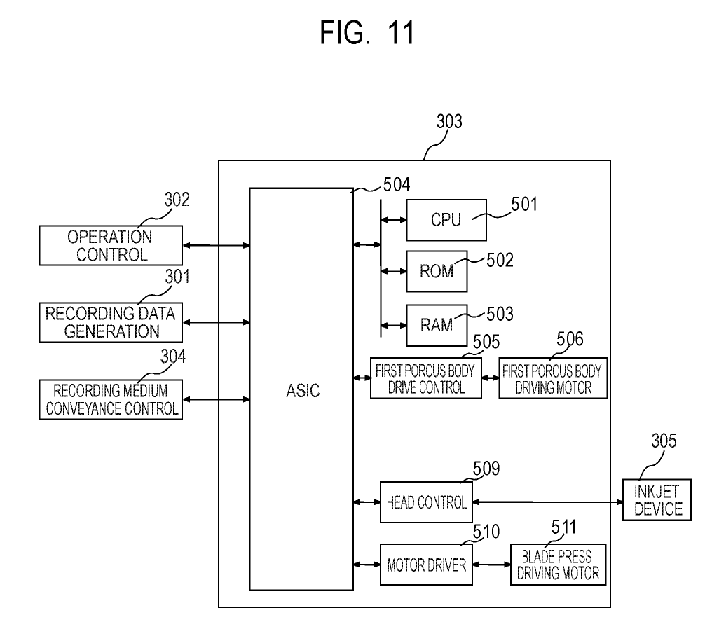

FIG. 11 is a block diagram of the printer control section of the direct drawing type inkjet recording par shown in FIG. 2. The block diagram of the printer control section of FIG. 11 is similar to the block diagram of the printer control section of the transfer type inkjet recording apparatus shown in FIG. 8 except that the direct drawing type inkjet recording apparatus does not have a transfer body drive control section 407 and a transfer body drive motor 408.

Referring to FIG. 11, 501 denotes the CPU for controlling the entire printer, 502 denotes a ROM for storing the control program of the CPU and 503 denotes a RAM to be used for executing the control program. 504 denotes an ASIC containing a network controller, a serial IF controller, an inkjet head data generation controller and a motor controller among others. 505 denotes a first porous body drive control section for driving first porous body driving motor 506, which is command-controlled from the ASIC 504 by way of a serial IF. 509 denotes an inkjet head control section that operates for generation of final ejection data of the inkjet device 305 and generation of the drive voltage among others. 510 denotes a motor driver for driving blade press driving motor 511, which is also command-controlled from the ASIC 504 by way of a serial IF.

Thus, the present invention can provide an inkjet recording method and an inkjet recording apparatus that can satisfactorily remove and collect the liquid component contained in ink images and also can reduce the energy load of the liquid absorbing unit to be used for collecting the liquid component.

### EXAMPLES

Now, the present invention will be described below in greater detail by way of examples and comparative examples. Note, however, the scope of the present invention is by no means limited by the examples unless departing from the spirit of the present invention. In the following description, “portions” are mass portions unless noted otherwise.

### Example 1

<Preparation of Aqueous Dispersion of Resin Particles 1>

18.0 portions of butyl methacrylate, 2.0 portions of polymerization initiator (2,2′-azobis(2-methylbutyronitril)) and 2.0 portions of n-hexadecane were put into a four-necked flask provided with an agitator, a reflux cooling device and a nitrogen gas feed pipe. Nitrogen gas was introduced into the reaction system, which was then agitated for 0.5 hours. Then, 78.0 portions of 6.0 mass % aqueous solution of emulsifier (NIKKOL BC15: trade name, available from Nikko Chemicals) were dropped into the flask, while the mixture was being agitated again for 0.5 hours. Thereafter, the mixture was emulsified by irradiating it with ultrasonic waves for 3 hours by means of an ultrasonic irradiation machine. Subsequently, a polymerization reaction was made to proceed in a nitrogen atmosphere at 80° C. for 4 hours. After cooling the reaction system to 25° C., the components were filtered and an appropriate amount of pure water was added thereto to prepare aqueous dispersion of the resin particles 1, whose content ratio of the resin particles 1 (solid content) was 20.0 mass %.

<Preparation of Aqueous Solution of Resin 1>

Styrene-ethyl acrylate-acrylic acid copolymer (resin 1) whose acid value was 150 mgKOH/g and weight average molecular weight was 8,000 was prepared. 20.0 portions of the resin 1 was neutralized with equimolar potassium hydroxide of the acid value and an appropriate amount of pure water was added thereto to prepare aqueous solution of the resin 1, whose content ratio of the resin (solid content) was 20.0 mass %.

<Preparation of Pigment Dispersion K>

10.0 portions of pigment (carbon black), 15.0 portions of the aqueous solution of the resin 1 and 75.0 portions of pure water were mixed. The mixture and 200 portions of zirconia beads having a diameter of 0.3 mm were put into a batch vertical sand mill (available from Aimex) and dispersed for 5 hours, while the mixture was being cooled with water. Thereafter, coarse particles were removed by centrifugation and the remains were filtered under pressure by means of a cellulose acetate filter (available from Advantec) of pore diameter of 3.0 μm to prepare pigment dispersion K, of which the pigment content ratio was 10.0 mass % and the content ratio of the resin 1, which was the resin dispersant, was 3.0 mass %.

<Preparation of Ink>

The components listed in Table 1 below were mixed and thoroughly agitated. Thereafter, the mixture was filtered under pressure by means of a cellulose acetate filter (available from Advantec) of pore diameter of 3.0 μm to prepare black ink. Note that Acetylenol E100 (trade name) was a surfactant available from Kawaken Fine Chemicals.

TABLE 1

| | mass portions |
|---|---|
| pigment dispersion K | 20.0 |
| aqueous dispersion of resin particles 1 | 50.0 |
| aqueous solution of resin 1 | 5.0 |
| glycerin | 5.0 |
| diethylene glycol | 7.0 |
| acetylenol E100 | 0.5 |
| pure water | 12.5 |

<Preparation of Reaction Liquid>

The components listed below were mixed and thoroughly agitated. Thereafter, the mixture was filtered under pressure by means of a cellulose acetate filter (available from Advantec) of pore diameter of 3.0 μm to prepare reaction liquid.
levulinic acid: 40.0 portions
glycerin: 5.0 portions
Megaface F444: 1.0 portion (trade name: surfactant, available from DIC)
ion-exchange water: 54.0 portions

<Preparation of Transfer Body>

A sheet obtained by coating a 0.5 mm-thick PET sheet with silicone rubber (KE12: trade name, available from Shin-Etsu Chemical) to a thickness of 0.3 mm was employed as the elastic layer of a transfer body. Additionally, a mixture of a condensate obtained by mixing glycidoxypropyltriethoxysilane and methyltriethoxysilane to a molar ratio of 1:1 and heating the mixture to reflux and a photo-cationic resinization initiator (SP150: trade name, available from ADEKA) was prepared. The sheet for the elastic layer was subjected to an atmospheric pressure plasma treatment in order to make the contact angle of the surface of the elastic layer relative to water not greater than 10°. Thereafter, the above-described mixture was applied onto the elastic layer and turned to film by way of UV irradiation (high pressure mercury lamp, integrated exposure amount: 5,000 mJ/cm²) and thermosetting (150° C., 2 hours) to produce a transfer body having a 0.5 μm-thick surface layer formed on the elastic layer.

<Inkjet Recording Apparatus and Image Formation>

A transfer type inkjet recording apparatus 100 as shown in FIG. 1 was employed in this example. A transfer body prepared in the above-described manner was employed for the transfer body 101 of the inkjet recording apparatus 100. The transfer body 101 was rigidly secured to the surface of a supporting member 102 by means of a double sided sticky tape. The surface temperature of the transfer body 101 was held to 60° by a heating means (not shown).

The above-described reaction liquid was applied to the transfer body 101 by means of the reaction liquid applying unit 103. The reaction liquid was applied at a rate of 1 g/m² by means of the reaction liquid applying unit 103. Subsequently, the above-described ink was applied onto the transfer body 101 by means of the ink applying unit 104 to form an ink image. An inkjet head for ejecting ink on an on-demand basis by means of an electro-thermal transducer was employed for the ink applying unit 104. The ink was applied at a rate of 20 g/m².

Then, the first porous body 105 was brought into contact with the ink image formed on the transfer body 101 to absorb and remove the liquid component from the ink image. A porous body made of PTFE (polytetrafluoroethylene) and having a pore diameter (d1) of 0.5 μm was employed for the first porous body 105. The surface free energy (γs1) of the first porous body 105 was 28 mN/m and the contact angle (θ1) of the first porous body 105 relative to the ink was 40°, while the capillary force (F1) of the first porous body 105 that was determined by means of the above-described formula (a) was 42.9 kPa. Pressure was applied so as to make the nip pressure between the transfer body 101 and the first porous body 105 show an average pressure of 2 kg/cm². Both the first porous body and the second porous body were driven to rotate in the sense indicated by the related arrow in FIG. 1. The revolving speed of the first porous body 105 was adjusted so as to become substantially equal to the moving speed of the transfer body 101.

The liquid component absorbed by the first porous body 105 was then absorbed by the second porous body 110 (the first collecting step). A porous body formed by using a polyethylene-made elastic body showing a pore diameter (d2) of 1.0 μm and a hardness of 60 was employed for the second porous body 110. The surface free energy (γs2) of the second porous body 110 was 36 mN/m and the contact angle (θ2) of the surface of the second porous body 110 relative to the ink was 10°. When the liquid component was absorbed by means of the second porous body 110, the pore diameter (d2′) of the second porous body 110 was made to be equal to 0.8 μm by causing the first porous body 105 to press the second porous body 110 by means of a blade made of POM (polyacetal). As a result, the capillary force (F2) of the second porous body at the time of the pressure application in the first collecting step that was determined by means of the formula (2) was 44.3 kPa. Thereafter, the pressure application was released in a state where the second porous body 110 was held in contact with the first porous body 105. Then, the liquid component absorbed by the second porous body 110 was sucked and collected by means of a liquid sucking device equipped with a suction pump in the state where the pressure application had been released (the second collecting step). Since no pressure was applied to the second porous body 110 at that time, the pore diameter of the second porous body 110 became to be equal to 1.0 μm. Thus, the capillary force (F3) of the second porous body 110 during the second collecting step as determined by means of the formula (3) was 35.5 kPa.

Thereafter, the recording medium 108 was brought into contact with the ink image from which liquid had been removed and the ink image after the liquid removal was transferred onto the recording medium 108 to form the image on the recording medium 108 by pinching and pressing the ink image after the liquid removal and the recording medium 108 between the supporting member 102 and the pressing member 106 for image transfer. The recording medium 108 was conveyed by means of the recording medium feed roller 107a and the recording medium take-up roller 107b so as to make the moving speed of the recording medium 108 to be substantially equal to the moving speed of the transfer body 101. The conveying speed of the recording medium 108 was made to be equal to 0.5 m/s. Aurora Coat paper (trade name, available from Nippon Paper Industries, basis weight: 104 g/m²) was used for the recording medium 108.

Note that the pore diameters (d1, d2 and d2′), the surface free energies (γs1 and γs2) and the contact angles (θ1 and θ2) of the first and second porous bodies were measured by the respective methods that will be described below.

[Method of Measuring the Pore Diameters of the Porous Bodies]

Each pore diameter value of the porous bodies (before pressure application) is an average of twenty values each measured by observing a pore on the surface of a porous body by an optical microscope and calculating the diameter of the pore supposing that the pore has a circular shape at the surface having the same area as the circle. The value of pore diameter of each porous body during pressure application was calculated by multiplying the pore diameter (before pressure application) of the porous body with the compression ratio when a pressure was applied. The compression ratio was measured by using a fixability simulator (FSR 1000 manufactured by Rhesca). Specifically, data showing the relation between the compression ratio and the pressure applied to the porous body were obtained in advance by using the fixability simulator, and the pore diameter of each porous body during pressure application was determined by adjusting the applied pressure to the porous body to be used for the inkjet recording apparatus in each of the examples and the comparative examples. When the pore diameter of a porous body is small and difficult to measure by using an optical microscope, the pore diameter may be measured by using an electron microscope.

[Method of Measuring the Surface Free Energies of the Porous Bodies]

The surface free energies (γs1 and γs2) can be determined by observing the contact angles of a plurality of liquid substances whose surface free energies are known. In this example, a DropMaster700 (trade name, available from Kyowa Interface Science) was used for measuring γs1 and γs2. A plurality of liquid substances (water, diiodomethane, formamide, n-hexadecane and ethylene glycol) whose surface free energies are known were used and the contact angles relative to the respective liquid substances were observed and their respective surface free energies were determined by means of the Kitazaki-Hata equation.

[Method of Measuring the Contact Angles of the Porous Bodies]

The contact angle of each porous body relative to the ink was measured by using an automatic contact angle meter (available from Kyowa Interface Science, CA-W)

[Evaluation]

The smeared image and the energy load of the liquid sucking device were evaluated by means of the method as described below. The expression of “smeared image” as used herein refers to a phenomenon that part of the liquid, the coloring material and the solid components other than the coloring material in the ink are washed away toward the rear edge of the image to distort the image. For the purpose of this invention, ratings A and B are defined to be agreeable, whereas rating C was defined as inacceptable for each of the evaluation items listed below.

<Smeared Image>

The obtained images were evaluated according to the rating system shown below. Table 2 shows the results. In this example, smeared image occurred when the liquid component was not sufficiently absorbed from the first porous body by the second porous body so that, as a result, the liquid component was partly left in the first porous body and the liquid component was not sufficiently absorbed from the ink image on the transfer body by the first porous body.

A: No smeared image was confirmed.
B: Smeared image was confirmed to a small extent but not objectionable at all.
C: Smeared image was confirmed to a large extent.

<Energy Load of Liquid Sucking Device>

The capillary force (F2) of the second porous body during the pressure application in the first collecting step and the capillary force (F3) of the second porous body in the second collecting step were determined by means of the above-described formulas (b) and (c). The energy load of the suction pump of the liquid sucking device was evaluated according to the rating system shown below. Table 2 shows the results. Note that, when the requirement of F3<F2 is satisfied, the second porous body sucks the liquid component in the second collecting step with capillary force smaller than F2 to reduce the energy load of the suction pump.

A: F3<F2 was satisfied.
C: F3≥F2 was satisfied.

### Examples 2 Through 4

Images were formed in these examples as in Example 1 except that the pore diameter (d2) of the second porous body and the pore diameter (d2′) of the second porous body during the pressure application in the first collecting step were modified to the values of the respective examples as shown in Table 2. Table 2 also shows the results.

### Comparative Examples 1 Through 3

In each of these comparative examples, a porous body made of sintered polyethylene and having a pore diameter (d2) as shown in Table 2 was employed for the second porous body. Additionally, no pressure was applied to the second porous body in the first collecting step and hence the pore diameter (d2′) of the second porous body was made equal to the pore diameter (d2) in the step. Otherwise, images were formed in these comparative examples as in Example 1 and evaluated. Table 2 shows the results.

TABLE 2

| | | | | | | | | | evaluation |
|---|---|---|---|---|---|---|---|---|---|
| | | | | | | | | | of energy |
| | | | | | | | | | load of |
| | | | | | | | | evaluation | liquid |
| | d2 | d2′ | γs2 | θ2 | F1 | F2 | F3 | of smeared | sucking |
| | (μm) | (μm) | (mN/m) | (°) | (kPa) | (kPa) | (kPa) | image | device |
| Example 1 | 1.0 | 0.8 | 36 | 10 | 42.9 | 44.3 | 35.5 | A | A |
| Example 2 | 0.8 | 0.6 | 36 | 10 | 42.9 | 59.1 | 44.3 | A | A |
| Example 3 | 1.5 | 1.0 | 36 | 10 | 42.9 | 35.5 | 23.6 | B | A |
| Example 4 | 10.0 | 5.0 | 36 | 10 | 42.9 | 7.1 | 3.5 | B | A |
| Comp Ex 1 | 0.2 | 0.2 | 36 | 10 | 42.9 | 177.3 | 177.3 | A | C |
| Comp Ex 2 | 0.5 | 0.5 | 36 | 10 | 42.9 | 70.9 | 70.9 | A | C |
| Comp Ex 3 | 20.0 | 20.0 | 36 | 10 | 42.9 | 1.8 | 1.8 | C | A |

As shown in FIG. 2, no smeared image took place or smeared image was confirmed only to a small extent in each of Examples 1 through 4 to prove that the liquid component had sufficiently been collected from the first porous body by the second porous body. Additionally, since d2′<d2, the requirement of F3<F2 was satisfied to reduce the load energy of the liquid sucking device. On the other hand, the requirement of F3<F2 was not satisfied because d2′=d2 in Comparative Examples 1 and 2 and hence the energy load of the liquid sucking device was not reduced. In Comparative Example 3, no pressure was applied to the second porous body in the first collecting step and F1>F2 held true so that it may be safe to assume that it was difficult for the second porous body to collect the liquid component from the first porous body and hence smeared image took place in this comparative example.

Additionally, images were formed by means of a direct drawing type inkjet recording apparatus 200 as shown in FIG. 2 and evaluated. GLORIA pure white paper (trade name, available from GOJO Paper MFG., basis weight: 210 g/cm²) was used for the recording medium 208. Other than the recording medium 208, namely the composition of the reaction liquid, the reaction liquid applying unit 203, the ink composition, the ink applying unit 204, the conveying speed of the recording medium 208, the first porous body 205 and the second porous body 210 were the same as their counterparts of the transfer type inkjet recording apparatus of Example 1. It was confirmed that the obtained results were similar to those of Example 1.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-127483, filed Jun. 29, 2017, hereby incorporated by reference herein in its entirety.

What is claimed is:

1. An inkjet recording method comprising:
a step of applying a reaction liquid onto an ejection receiving medium, the reaction liquid increasing viscosity of an ink by contacting with the ink;
a step of applying the ink so as to make the applied ink overlap at least part of a region having the reaction liquid applied thereto, thereby forming an ink image on the ejection receiving medium;
a step of bringing a first porous body into contact with the ink image, thereby removing at least part of a liquid component contained in the ink image;
a first collecting step of absorbing the liquid component contained in the first porous body by means of a second porous body; and
a second collecting step of sucking and collecting the liquid component contained in the second porous body,
wherein the pore diameter of the second porous body is so controlled in the first collecting step as to be firstly made smaller by means of pressure application to the second porous body than the pore diameter of the second porous body prior to the pressure application and subsequently diameter made larger by lowering or releasing the applied pressure than the pore diameter of the second porous body during the pressure application in a state that the second porous body is held in contact with the first porous body, and
wherein the liquid component is collected in the second collecting step in a state that the pore diameter of the second porous body is made larger than the pore diameter of the second porous body during the pressure application in the first collecting step.

2. The method according to claim 1, wherein
the position of the second porous body, where the pore diameter of the second porous body is controlled so as to be made smaller, is to be shifted in the first collecting step.

3. The method according to claim 1, wherein
the second porous body is formed by an elastic body.

4. The method according to claim 3, wherein
air is used for the pressure application.

5. The method according to claim 3,
a blade is used for the pressure application.

6. The method according to claim 1, wherein
the first porous body and the second porous body are not held in contact with each other in the second collecting step.

7. The method according to claim 1, wherein
the pore diameter of the second porous body is so controlled as to satisfy the requirement of formula (1) given below:
γs1 cos θ1/d1<γs2 cos θ2/d2′ (1)
where:
the symbol γs1 denotes the surface free energy of the first porous body;
the symbol d1 denotes the pore diameter of the first porous body;
the symbol θ1 denotes the contact angle of the first porous body relative to the ink contacting it;
the symbol γs2 denotes the surface free energy of the second porous body;
the symbol d2 denotes the pore diameter of the second porous body prior to the pressure application;
the symbol θ2 denotes the contact angle of the second porous body relative to the ink contacting it; and
the symbol d2′ denotes the pore diameter of the second porous body during the pressure application in the first collecting step.

8. The method according to claim 1, wherein
the pore diameter of the first porous body is not less than 0.2 μm and not more than 10 μm.

9. The method according to claim 1, wherein
the pore diameter of the second porous body prior to the pressure application in the first collecting step is not less than 0.5 μm and not more than 30 μm.

10. The method according to claim 1, wherein
the pore diameter of the second porous body during the pressure application in the first collecting step is not less than 0.1 μm and not more than 10 μm.

11. The method according to claim 1, wherein
the pore diameter of the second porous body in the second collecting step is not less than 1 μm and not more than 30 μm.

12. An inkjet recording apparatus comprising:
an ejection receiving medium;
a reaction liquid applying unit for applying a reaction liquid for increasing viscosity of an ink by contacting the ink onto the ejection receiving medium;
an ink applying unit having an inkjet head for forming an ink image on the ejection receiving medium by applying the ink so as to make the applied ink overlap at least part of a region having the reaction liquid applied thereto;
a liquid absorbing unit having a first porous body for removing at least part of a liquid component contained in the ink image by contacting with the ink image; and
a liquid collecting unit having a second porous body for absorbing the liquid component contained in the first porous body, a pore diameter control system for controlling the pore diameter of the second porous body so as to be firstly made smaller by means of pressure application to the second porous body than the pore diameter of the second porous body prior to the pressure application and subsequently made larger by lowering or releasing the applied pressure than the pore diameter of the second porous body during the pressure application in a state that the second porous body is held in contact with the first porous body at the time of absorbing the liquid component contained in the first porous body by means of the second porous body, and a liquid sucking device for sucking and collecting the liquid component contained in the second porous body.
